(19) United States
(12) Patent Application Publication
(10) Pub. No.: US 2009/0157759 A1
(43) Pub. Date: Jun. 18, 2009

(54) APPARATUS AND METHOD FOR DOCUMENT MANAGEMENT

(75) Inventors: Eric KUNISAKI, Honolulu, HI (US); Paul KOMEIJI, Honolulu, HI (US)

Correspondence Address: COOLEY GODWARD KRONISH LLP;ATTN: Patent Group, Suite 1100, 777 - 6th Street, NW, Washington, DC, 20001, US

(73) Assignee: DISCOVERYBOX, INC., Honolulu, HI (US)

(21) Appl. No.: 12/131,007

(22) Filed: May 30, 2008

Related U.S. Application Data
(60) Provisional application No. 61/014,192, filed on Dec. 17, 2007.

(51) Int. Cl. G06F 17/30

(52) U.S. Cl. 707/200; 707/E17.005

(57) ABSTRACT

A computer readable storage medium including executable instructions to manage documents subject to legal holds by performing two or more of the following operations is disclosed. The operations include executable instructions to manage a document release, execute a drill down analysis, execute an assigned search, assign a code alert, re-use documents associated with a custodian and manage a document assignment and review process.

### CROSS REFERENCE TO RELATED APPLICATIONS

This application claims the benefit of U.S. Provisional Application Ser. No. 61/014,192, entitled “Apparatus and Method for Electronically Managing Documents Subject to Legal Holds”, filed Dec. 17, 2007, the contents of which are hereby incorporated by reference in their entirety.

### FIELD OF THE INVENTION

The invention relates generally to document management. More particularly, the invention relates to techniques for managing documents subject to legal holds.

### BACKGROUND OF THE INVENTION

Currently corporations manage documents subject to legal holds by retaining these documents in the system for long periods of time before deleting them. As a result, corporations open themselves to an increased business risk since critical information is generally stored in these documents. It would be desirable to develop an efficient technique to manage the assignment and release of documents subject to multiple legal holds. It would also be desirable to develop an efficient technique to manage documents subject to legal holds in a corporation by analyzing and monitoring various relationships between the documents and various entities in a corporation.

Further, corporations generally perform document reviews based on a document review process. It is critical that a document review process achieves the necessary quality, consistency and review speed typically required for a document review. It would be desirable to develop an efficient document review technique that increases the efficiency of a reviewer's review process, organizes the review process, generates consistent results across a review process, enhances the speed of a review process and minimizes document review time.

Current document review processes generally involve the manual assignment of documents to reviewers. Typically each reviewer is assigned a single folder with documents to be reviewed. Upon reviewing the documents, the reviewer contacts a Review Manager who then manually assigns additional documents for each reviewer to review. It would be desirable to develop a technique by which a reviewer can be automatically assigned multiple documents for review in a document review process.

### SUMMARY OF THE INVENTION

In one embodiment, a computer readable storage medium is disclosed. The computer readable storage medium includes executable instructions to manage documents subject to legal holds by performing two or more of the following operations. The operations include executable instructions to manage a document release, execute a drill down analysis, execute an assigned search, assign a code alert, re-use documents associated with a custodian and mange a document assignment and review process.

### BRIEF DESCRIPTION OF THE FIGURES

The invention is more fully appreciated in connection with the following detailed description taken in conjunction with the accompanying drawings, in which:

FIG. 1 illustrates a computer configured in accordance with one embodiment of the present invention.

FIG. 2 is a flowchart illustrating exemplary operations for managing documents subject to legal holds, in accordance with one embodiment of the present invention.

FIG. 3 is a flowchart illustrating exemplary operations performed to manage a document release, in accordance with one embodiment of the present invention.

FIG. 4 is an exemplary screen display presented to a user to view a list of document-matter descriptions.

FIG. 5 is an exemplary screen display presented to a user to select a document-matter description.

FIG. 6 is an exemplary screen display that displays a list of custodians assigned to a document-matter description.

FIG. 7 is an exemplary screen display presented to a user to view a selected custodian assigned to a selected document-matter description.

FIG. 8 is an exemplary screen display presented to a user to release a selected custodian assigned to a selected document-matter description.

FIG. 9 is an exemplary screen display presented to a user to confirm the release of a custodian from a document-matter description.

FIG. 10 is a flowchart illustrating exemplary operations for executing a drill down analysis, in accordance with one embodiment of the present invention.

FIG. 11 is a flowchart illustrating exemplary operations for executing a first-level drill down analysis, in accordance with one embodiment of the present invention.

FIG. 12 is an exemplary screen display presented to a user to view a list of document-matter descriptions.

FIG. 13 is an exemplary screen display presented to a user to select a document-matter description.

FIG. 14 is an exemplary screen display presented to a user that displays a first-level drill down resultant list.

FIG. 15 is an exemplary screen display presented to a user to select one or more business units.

FIG. 16 is an exemplary screen display presented to a user that displays a second-level drill down resultant list.

FIG. 17 is an exemplary screen display presented to a user to select one or more custodians.

FIG. 18 is an exemplary screen display presented to a user that displays a third-level drill down resultant list.

FIG. 19 is a flowchart illustrating exemplary operations for generating an assigned search, in accordance with one embodiment of the present invention.

FIG. 20 is an exemplary screen display presented to a user to execute a search related to a document-matter description assigned to a specific reviewer.

FIGS. 21-26 are exemplary screen displays presented to a user to generate a search string based on search criteria.

FIGS. 27-29 are exemplary screen displays presented to a user to assign the generated search string to a specific reviewer.

FIGS. 30-32 are exemplary screen displays presented to a user to execute and display the generated search string.

FIG. 33 is a flowchart illustrating exemplary operations performed to assign a code alert, in accordance with one embodiment of the present invention.

FIG. 34 is an exemplary screen display that is presented to a user to view a list of documents.

FIGS. 35-38 are exemplary screen displays presented to a user to create a code alert for selected documents.

FIGS. 39-40 are exemplary screen displays presented to a user to view code alerts assigned to selected documents.

FIG. 41 is a flowchart illustrating exemplary operations performed to re-use documents, in accordance with one embodiment of the present invention.

FIG. 42 is an exemplary screen display presented to a user to view a list of document-matter descriptions.

FIG. 43 is an exemplary screen display presented to a user to select a first document-matter description.

FIG. 44 is an exemplary screen display that displays a list of custodians assigned to a document-matter description.

FIG. 45 is an exemplary screen display presented to a user to copy a selected custodian assigned to a selected document-matter description.

FIG. 46 is an exemplary screen display presented to a user to select a second document-matter description and execute an action to copy documents.

FIG. 47 is a flowchart illustrating exemplary operations performed for managing a document assignment and review process.

FIG. 48 is an exemplary screen display presented to a user to view a list of document pools.

FIG. 49 is an exemplary screen display presented to a user to edit a document pool selected from a list of document pools.

FIG. 50 is an exemplary screen display presented to a user to assign reviewers to a selected document pool.

FIG. 51 is an exemplary screen display of a reviewer assigned to a selected document pool.

FIG. 52 is an exemplary screen display presented to a user to modify a file size number assigned to a reviewer requesting documents from a document pool.

FIG. 53 is an exemplary screen display presented to a user to modify a priority ranking assigned to a document pool.

FIG. 54 is an exemplary review screen presented to a reviewer to manage a document assignment and review process.

FIG. 55 is an exemplary screen display that displays the files assigned to a reviewer.

Like reference numerals refer to corresponding parts throughout the several views of the drawings.

### DETAILED DESCRIPTION OF THE INVENTION

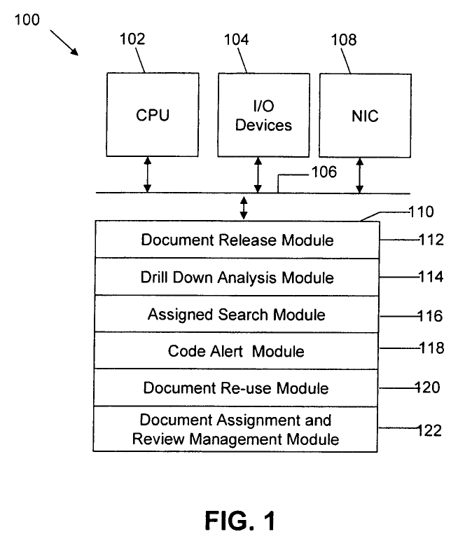

FIG. 1 illustrates a computer configured in accordance with one embodiment of the present invention. The computer 100 includes standard components, including a Central Processing Unit (CPU) 102 and input/output devices 104, which are linked by a bus 106. A Network Interface Circuit (NIC) 108 provides connectivity to a network (not shown), thereby allowing the computer 100 to operate in a networked environment.

A memory 110 is also connected to the bus 106. The memory 110 includes one or more executable modules to implement operations of the invention. In one embodiment, the memory 110 includes a Document Release Module 112, a Drill Down Analysis Module 114, an Assigned Search Module 116, a Code Alert Module 118, a Document Re-use Module 120 and a Document Assignment and Review Management Module 122. The Document Release Module 112 includes executable instructions to manage a release of a legal hold of one or more custodians assigned to one or more document-matter descriptions. The Drill Down Analysis Module 114 includes executable instructions to perform a drill down analysis of relationships between one or more business units, custodians, collections and document-matter descriptions. The Assigned Search Module 116 includes executable instructions to generate one or more reviewer-specific search strings. The Document Code Alert Module 118 includes executable instructions to assign a code alert. The Document Re-use Module 120 includes executable instructions to re-use documents associated with a custodian. The Document Assignment and Review Management Module 122 includes executable instructions to manage a document assignment and review process. The operations performed by the executable modules in the memory 110 are discussed in greater detail below.

It should be noted that the executable modules stored in memory 110 are exemplary. Additional modules, such as an operating system or graphical user interface module may also be included. It should be appreciated that the functions of the modules may be combined. In addition, the functions of the modules need not be performed on a single machine. Instead, the functions may be distributed across a network, if desired. Indeed, the invention is commonly implemented in a client-server environment with various components being implemented at the client-side and or server-side. It is the functions of the invention that are significant, not where they are performed or the specific manner in which they are performed.

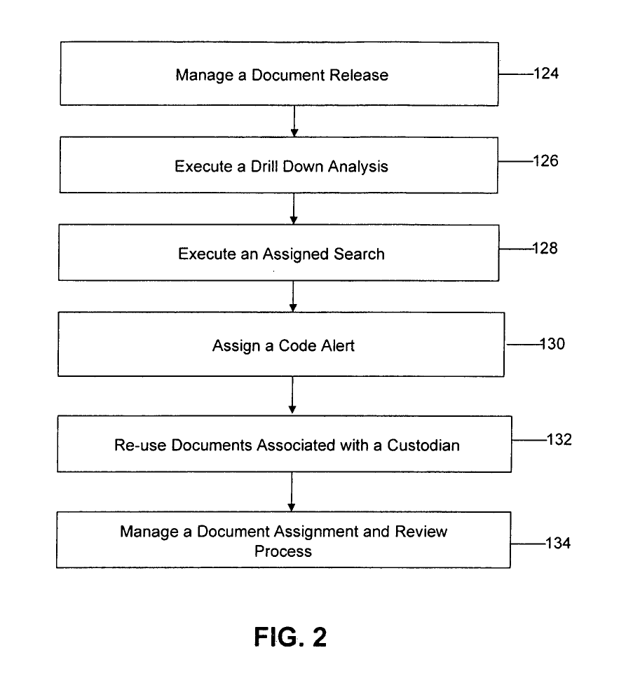

FIG. 2 is a flowchart illustrating exemplary operations for managing documents subject to legal holds, in accordance with one embodiment of the present invention. In a first embodiment, an operation to manage a document release is performed 124. In a second embodiment, an operation to execute a drill down analysis is performed 126. In a third embodiment, an operation to execute an assigned search is performed 128. In a fourth embodiment, an operation to assign a code alert is performed 130. In a fifth embodiment, an operation to re-use documents associated with a custodian is performed 132. In a sixth embodiment, an operation to manage a document assignment and review process is performed 134. The operations of FIG. 2 may be performed individually or in combination. Any combination in any order may be utilized in accordance with embodiments of the invention.

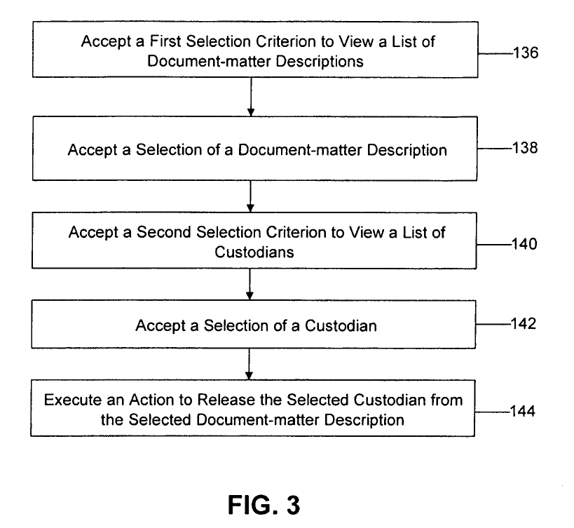

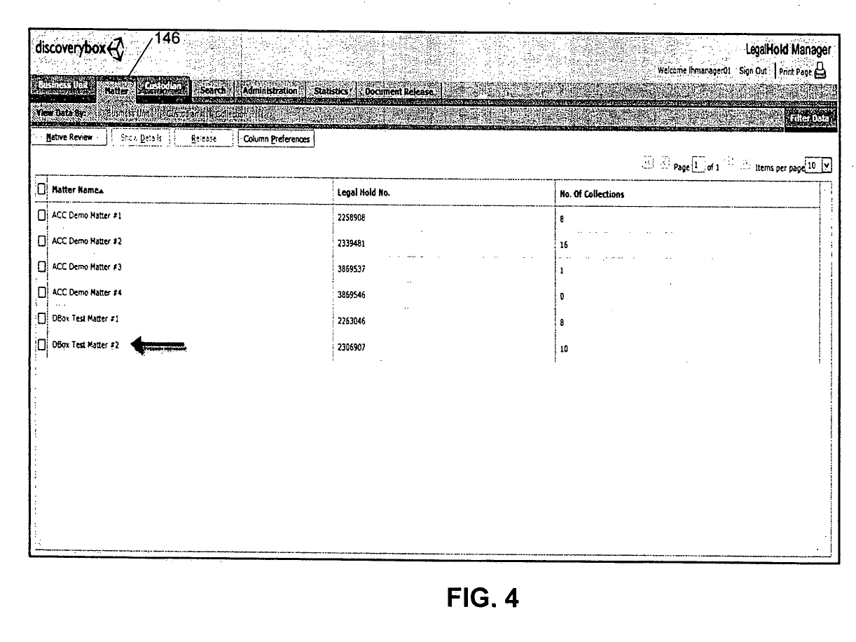

In accordance with a first aspect of the present invention, exemplary operations to manage a document release are disclosed. In one embodiment, the document release operation is performed by the Document Release Module 112. FIG. 3 is a flowchart illustrating exemplary operations performed to manage a document release, in accordance with one embodiment of the present invention. A first selection criterion to view a list of document-matter descriptions is accepted 136. As used herein, “a document-matter description” refers to a collection of documents related to a particular matter within a corporation or other business entity. A selection of one or more document-matter descriptions from the list of document-matter descriptions is then accepted 138. A second selection criterion to view a list of custodians assigned to one or more of the selected document-matter descriptions is accepted 140. A selection of one or more custodians from the list of custodians is accepted 142. An action to release each of the selected custodians assigned to each of the selected document-matter descriptions is executed 144. The operations 136-144 are more clearly understood with reference to the Graphical User Interface (GUI) screen displays shown in FIGS. 4-9.

FIG. 4 is an exemplary screen display presented to a user to view a list of document-matter descriptions. As illustrated, the user activates a “matter” tab 146 in the screen display to view a list of document-matter descriptions. Each document-matter description has an associated legal hold number indicating the presence of a legal hold on the document-matter description and a specified number of collections indicating the number of collections made against custodians assigned to a particular document-matter description.

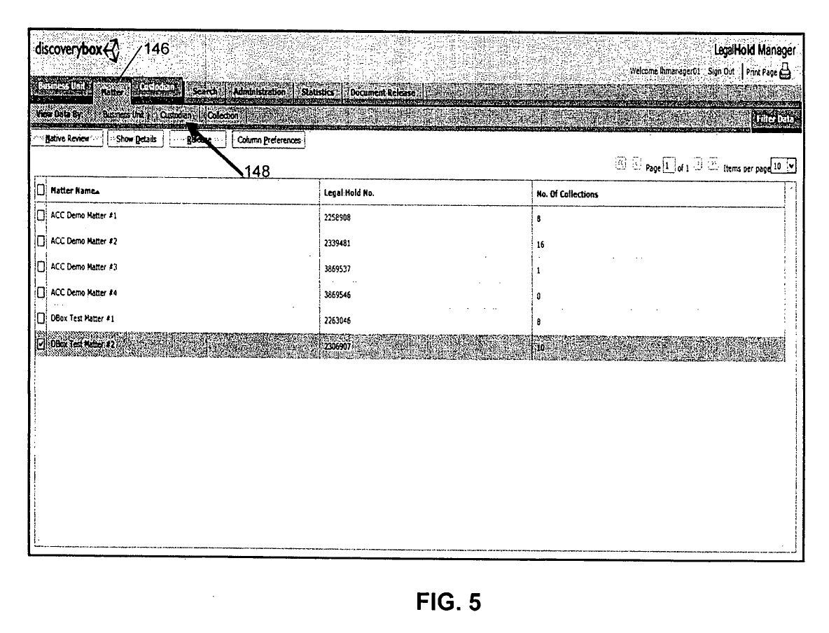

FIG. 5 is an exemplary screen display presented to a user to select a document-matter description. As illustrated, the user selects a particular document-matter description, “DBox Test Matter #2” from the list of document-matter descriptions. The user then activates a “custodian” tab 148 in the screen display to view a list of custodians assigned to the selected document-matter description.

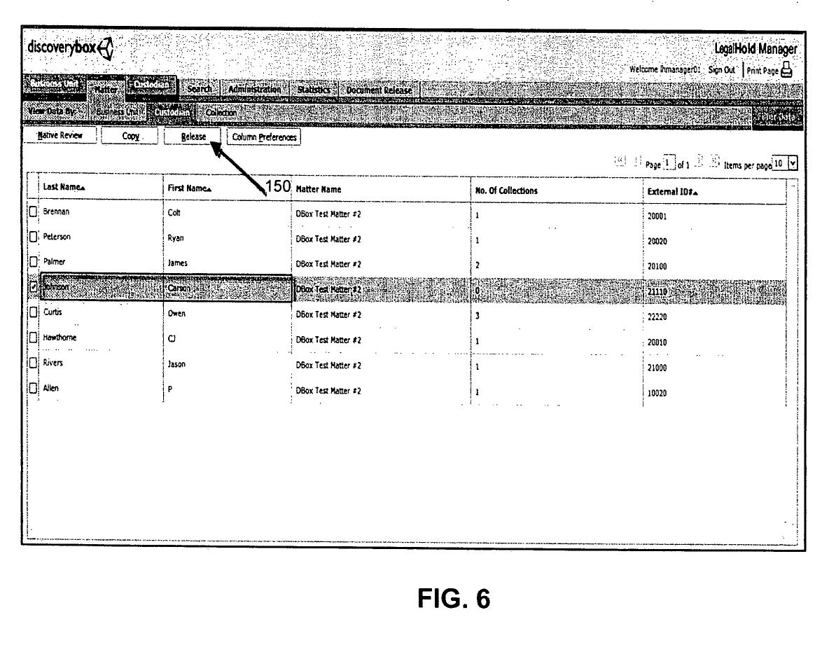

FIG. 6 is an exemplary screen display that displays a list of custodians assigned to document-matter description. In the illustrated example, a list of custodians assigned to the document-matter description, “DBox Test Matter #2” is displayed. The user then selects a particular custodian from the list of custodians. In the illustrated example, the user selects the custodian “Carson Johnson”. The user then executes an operation to initiate the release of the selected custodian from the selected document-matter description by activating the “Release” tab 150 in the screen display.

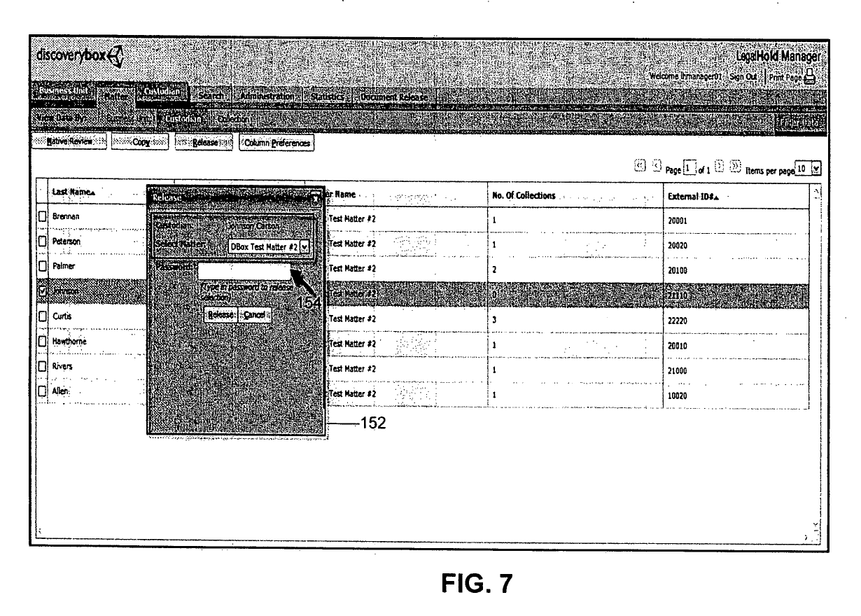

FIG. 7 is an exemplary screen display presented to a user to view a selected custodian assigned to a selected document-matter description. Upon activation of the “Release” tab 150, a release window 152 with the selected custodian, “Johnson Carson” and the selected document-matter description “DBox Test Matter#2” is displayed to the user. The user is also prompted to enter a password in a password field, 154, to confirm the release of the selected custodian from the selected document-matter description.

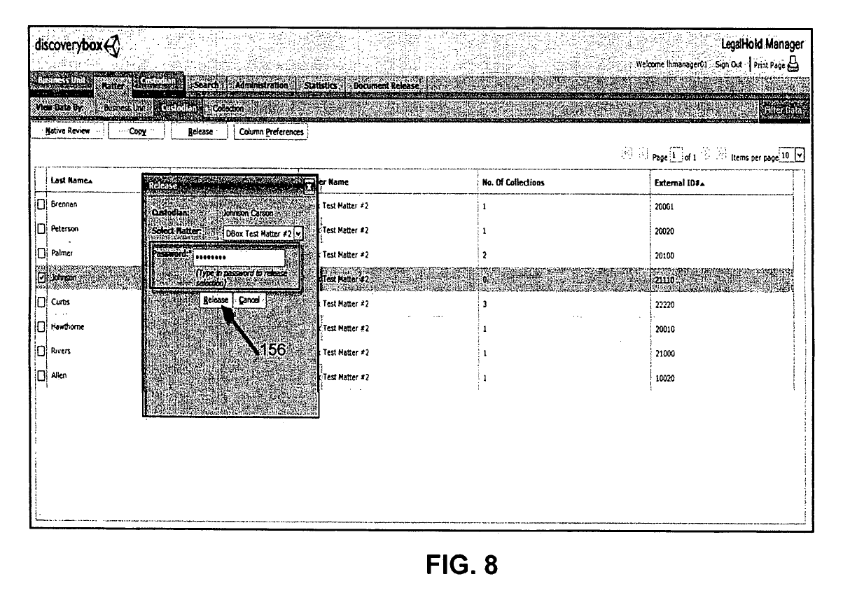

FIG. 8 is an exemplary screen display presented to a user to release a selected custodian assigned to a selected document-matter description. An action to release the selected custodian, “Johnson Carson” from the selected document-matter description, “DBox Test Matter#2” is executed when the user selects a “Release” button, 156 in the screen display.

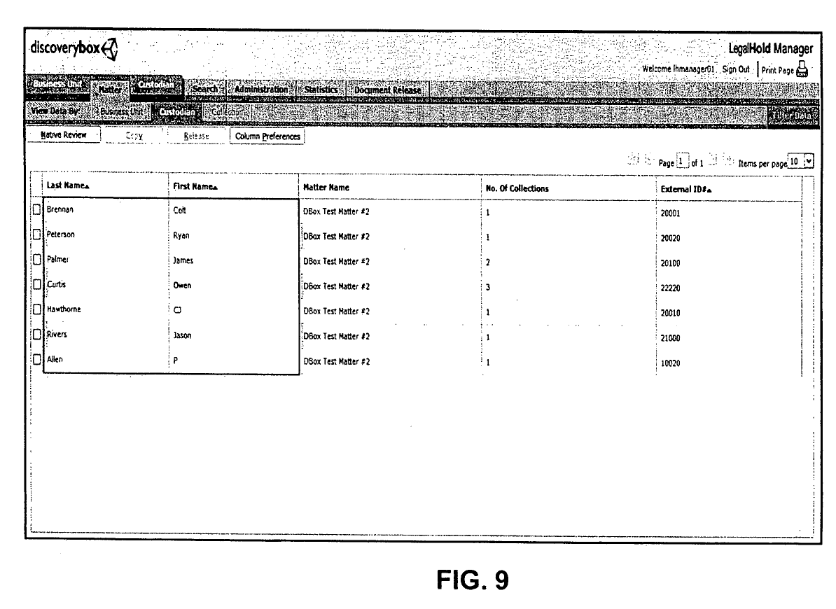

FIG. 9 is an exemplary screen display presented to a user to confirm the release of a custodian from a document-matter description. As illustrated, the selected custodian, “Carson Johnson” no longer appears in the list of custodians assigned to the document-matter description, “DBox Test Matter#2”, confirming that the legal hold of the selected custodian has been released from the selected document-matter description.

Note that the exemplary screen shots illustrated in FIGS. 4-9 describe operations that a user executes to release the legal hold of a custodian from a particular document-matter description, “DBox Test Matter#2”. However, it is to be appreciated that, in another embodiment, the user may also execute operations to release the legal hold of a custodian from more than one document-matter description. In a manner similar to the operations described in FIGS. 4-9, the selected custodian is released only after the legal hold of the custodian has been released from each of the document-matter descriptions. When all the legal holds have been released for a document-matter description, the documents in the document-matter description are also deleted. One skilled in the art will recognize that the disclosed technique of managing a document release ensures that a document is not prematurely deleted when it is subject to multiple legal holds. Also, by efficiently managing the release of document-matter descriptions and custodians from legal holds, the disclosed technique minimizes the business risk associated with storing documents having multiple legal holds.

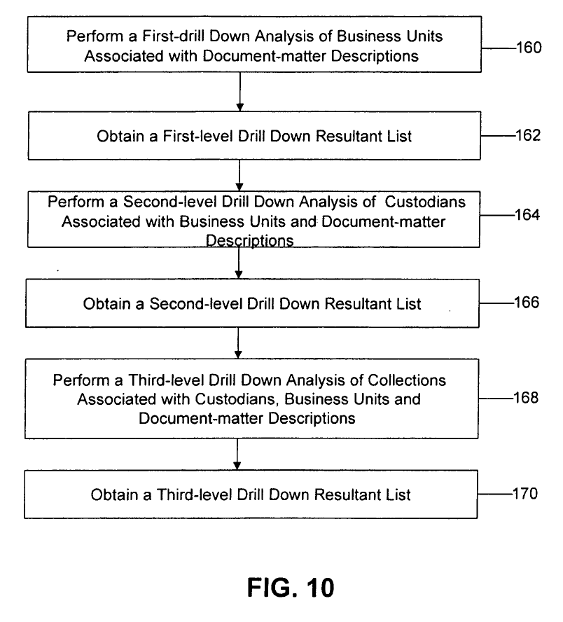

In accordance with a second aspect of the present invention, exemplary operations to execute a drill down analysis are disclosed. In one embodiment, the drill down analysis is performed by the Drill Down Analysis Module 114. FIG. 10 is a flowchart illustrating exemplary operations for executing a drill down analysis, in accordance with one embodiment of the present invention. A first-level drill down analysis of one or more business units associated with one or more document-matter descriptions is performed 160. A first-level drill down resultant list is obtained 162. The first-level drill down resultant list displays business units associated with one or more selected document-matter descriptions. A second-level drill down analysis of custodians associated with business units and document-matter descriptions is performed based on the first-level drill down resultant list 164. A second-level drill down resultant list is obtained 166. The second-level drill down resultant list displays one or more custodians associated with selected business units, for selected document-matter descriptions. A third-level drill down analysis of one or more collections associated with one or more custodians, one or more business units and one or more document-matter descriptions is performed based on the second-level drill down analysis list 168. A third-level drill down resultant set is obtained 170. The third-level drill down resultant list displays one or more collections associated with one or more custodians for each selected business unit and each selected document-matter description.

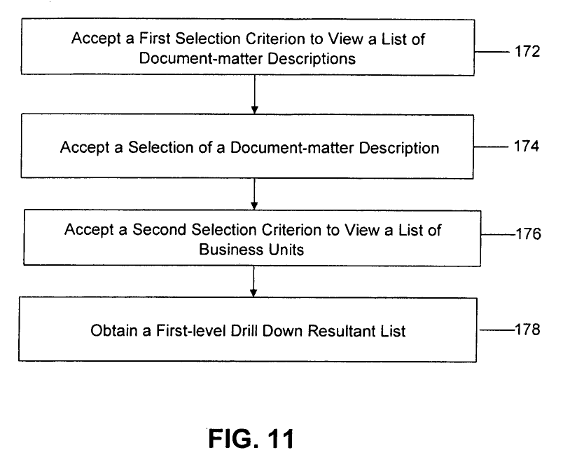

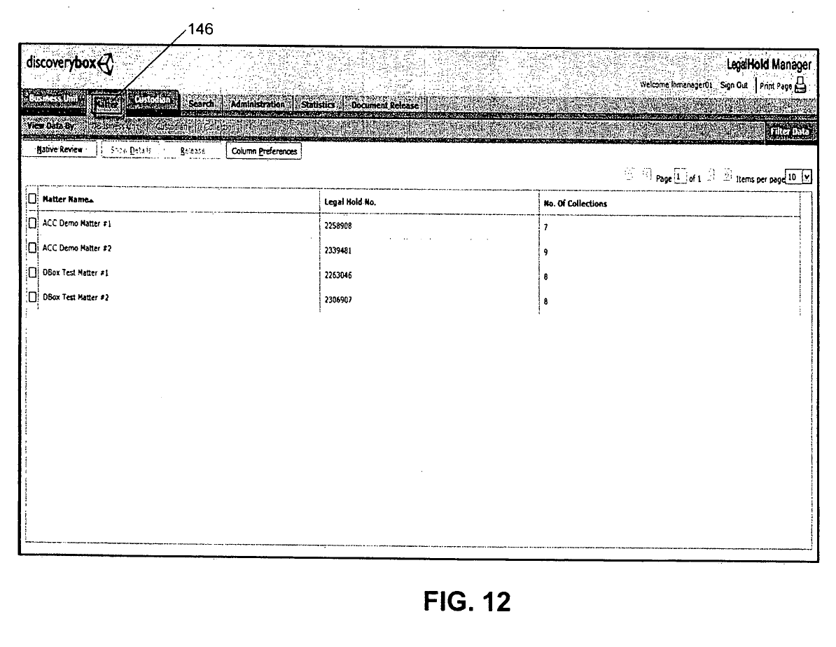

FIG. 11 is a flowchart illustrating exemplary operations for executing a first-level drill down analysis, in accordance with one embodiment of the present invention. A first selection criterion to view a list of document-matter descriptions is accepted 172. A selection of one or more document-matter descriptions from the list of document-matter descriptions is accepted 174. A second selection criterion to view a list of business units associated with one or more of the selected document-matter descriptions is accepted 176. A first-level drill down resultant list that displays the business units associated with one or more of the selected document-matter descriptions is obtained 178. The operations, 160-170 and 172-178 are more clearly appreciated with reference to the Graphical User Interface (GUI) screen displays shown in FIGS. 12-18.

FIG. 12 is an exemplary screen display presented to a user to view a list of document-matter descriptions. As illustrated, the user activates a “matter” tab 146 in the screen display to view a list of document-matter descriptions. Each document-matter description has an associated legal hold number indicating the presence of a legal hold on the document-matter description and a specified number of collections indicating the number of collections made against custodians assigned to a particular document-matter description.

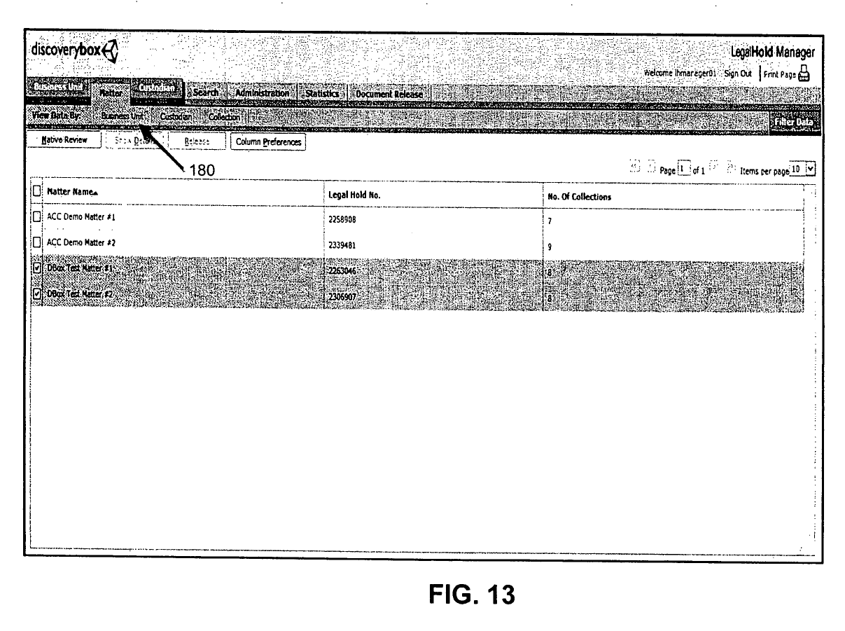

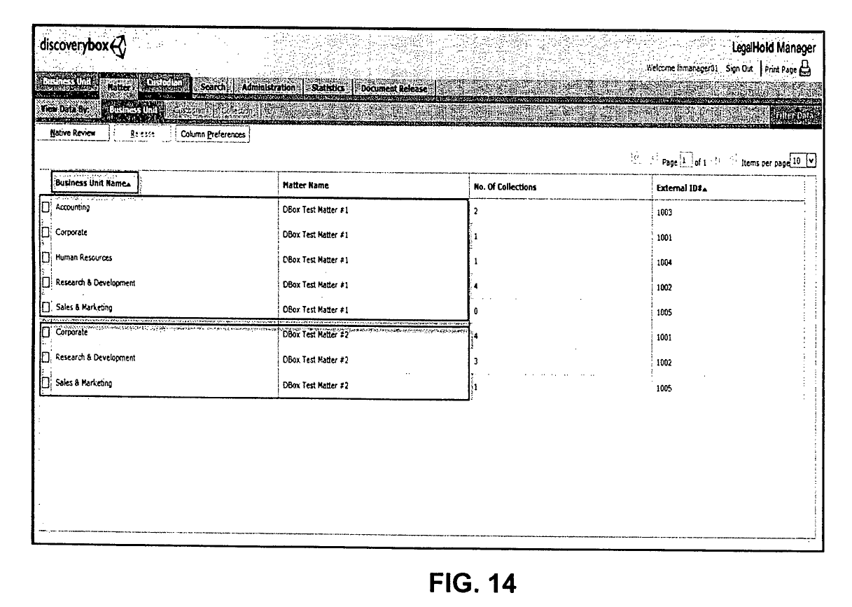

FIG. 13 is an exemplary screen display presented to a user to select a document-matter description. As illustrated, the user selects the document-matter descriptions, “DBox Test Matter #1” and “DBox Test Matter #2” from the list of document-matter descriptions. The user then activates a “business unit” tab 180 in the screen display to view a list of business units associated with the selected document-matter descriptions. A first-level drill down resultant list of business units associated with the document-matter descriptions, “DBox Test Matter#1” and “DBox Test Matter #2” is displayed to the user, as illustrated in the exemplary screen display shown in FIG. 14.

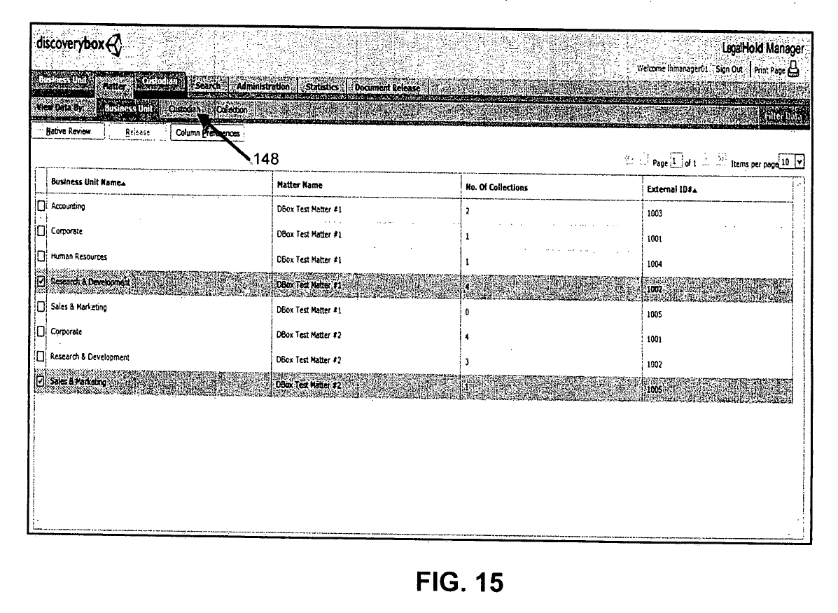

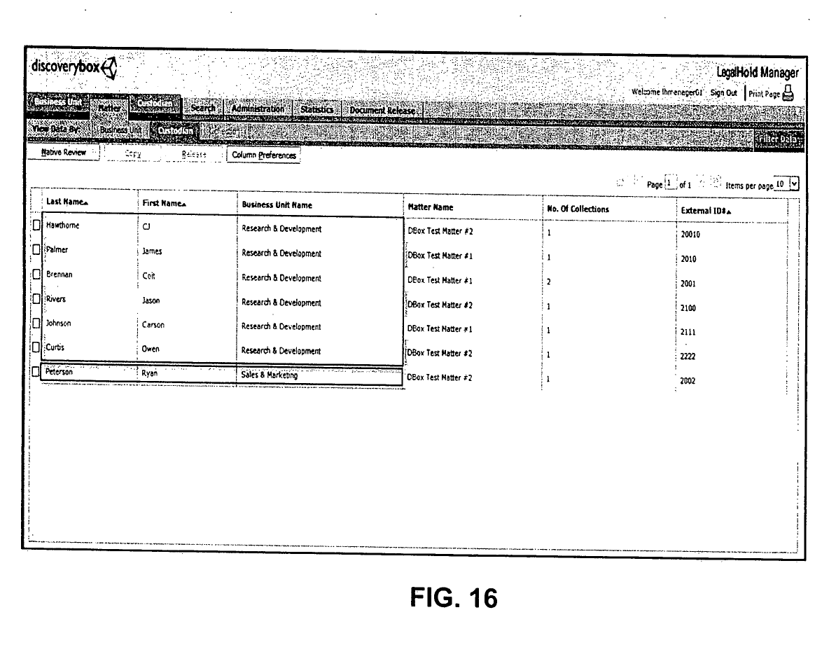

The operations to obtain a second-level drill down resultant list are performed similarly. FIG. 15 is an exemplary screen display presented to a user to select one or more business units. As illustrated, the user selects the business units, “Research & Development” and “Sales & Marketing” and then selects the “custodian” tab 148 to view a list of custodians associated with the selected business units for the selected document-matter descriptions, “DBox Test Matter#1” and “DBox Test Matter#2”. A second-level drill down resultant list of custodians associated with each of the selected business units, “Research & Development” and “Sales & Marketing” for each of the selected document-matter descriptions, “DBox Test Matter#1” and “DBox Test Matter#2 is displayed to the user, as illustrated in the exemplary screen display shown in FIG. 16.

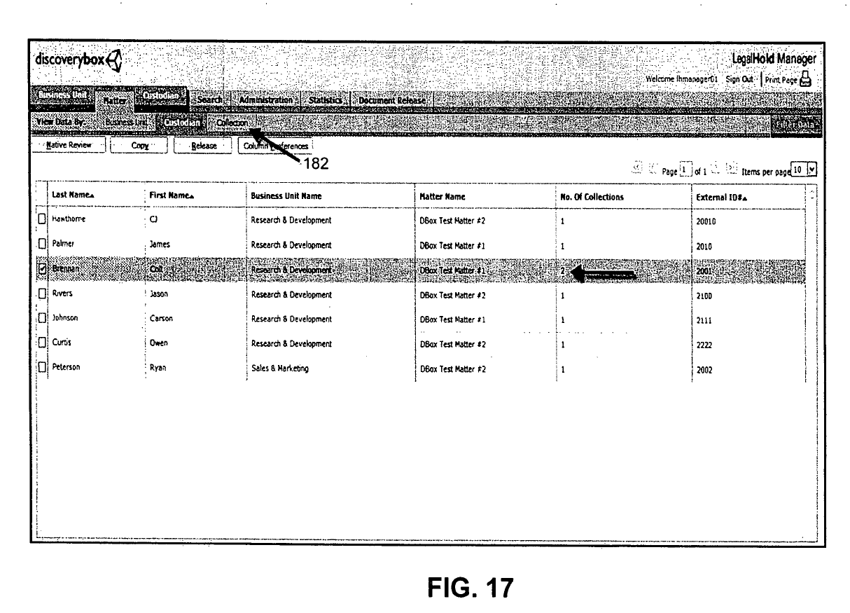

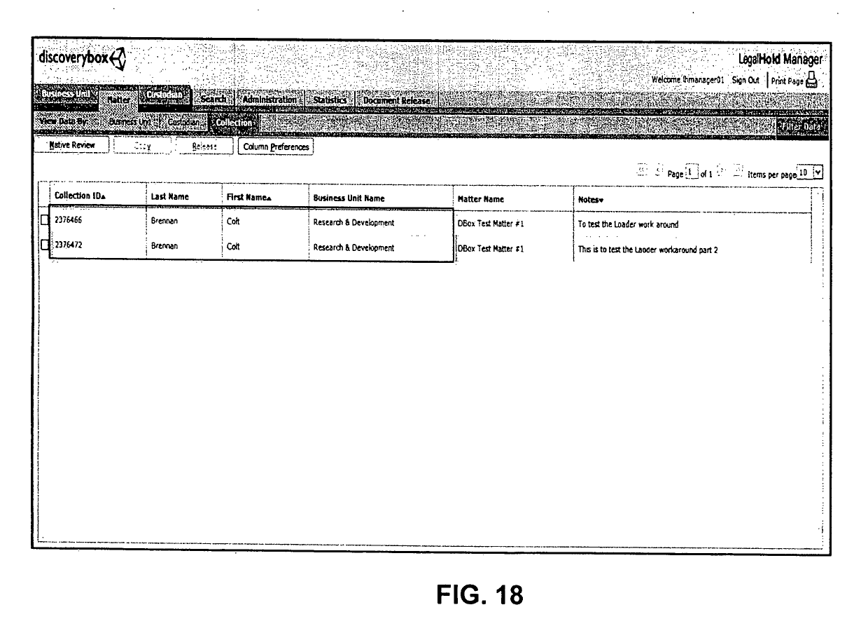

A third-level drill down analysis may then be performed based on the second-level drill down resultant list. FIG. 17 is an exemplary screen display presented to a user to select one or more custodians. As illustrated, the user selects a custodian, “Brennan” and then selects the “collection” tab 182 to view a list of collections associated with the selected custodian for the selected business units, “Research & Development” and “Sales & Marketing” and the selected document-matter descriptions, “DBox Test Matter#1” and “DBox Test Matter#2. A third-level drill down resultant list of the collections associated with a selected custodian for the selected business units and the selected document-matter descriptions is displayed to the user, as illustrated in the exemplary screen display shown in FIG. 18.

Those skilled in the art will recognize that the disclosed drill down analysis technique can be used to efficiently manage, monitor and analyze relationships between one or more entities in a corporation, such as business units, custodians and document collections in a single view. The disclosed multi-level drill down technique provides the user with a unique way of analyzing data by iteratively filtering the data through multiple levels, while preserving data relationships between one or more entities in the corporation throughout the multi-level drill down process.

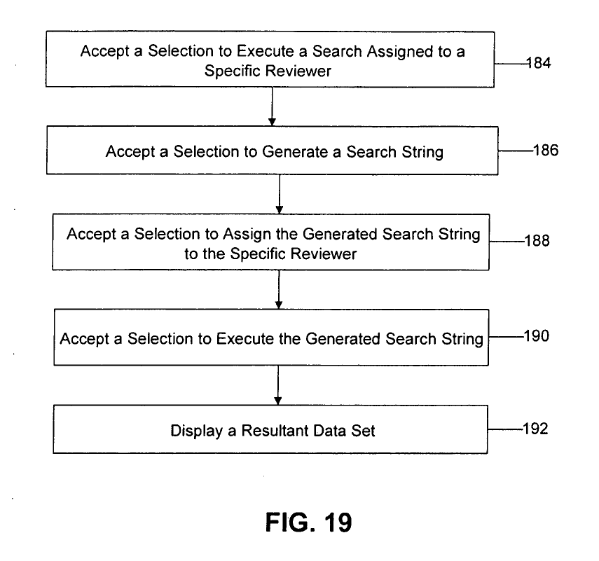

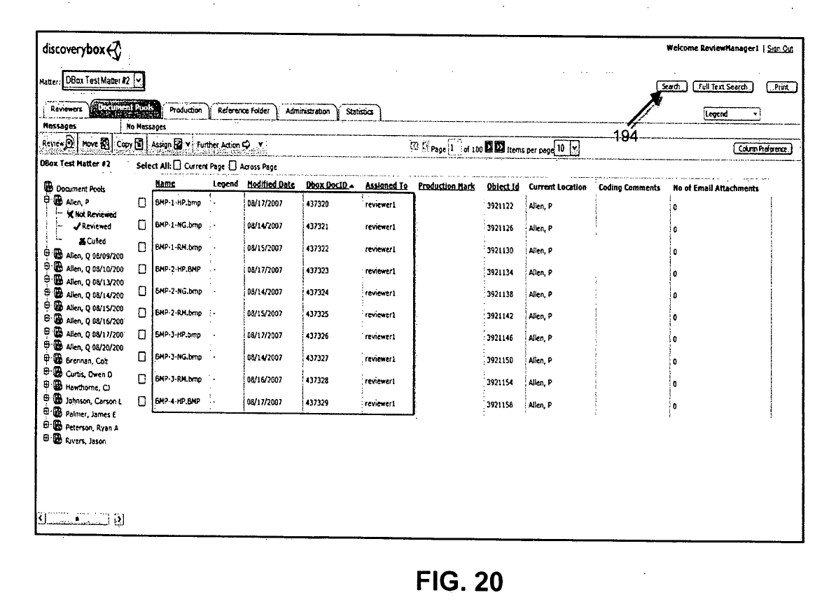

In accordance with a third aspect of the present invention, exemplary operations to execute an assigned search are disclosed. In one embodiment, the assigned search operation is performed by the Assigned Search Module 114. FIG. 19 is a flowchart illustrating exemplary operations for generating an assigned search, in accordance with one embodiment of the present invention. A selection to execute a search related to a document-matter description comprising one or more documents assigned to a specific reviewer is accepted 184. A selection to generate a search string to be executed on one or more documents based on search criteria is accepted 186. A selection to assign the generated search string to the specific reviewer is accepted 188. A selection to execute the generated search string is accepted 190. A resultant data set with one or more documents assigned to the reviewer that match the search string criteria is displayed 192. The operations 184-192 are more clearly appreciated with reference to the Graphical User Interface (GUI) screen displays shown in FIGS. 20-32.

FIG. 20 is an exemplary screen display presented to a user to execute a search related to a document-matter description assigned to a specific reviewer. As illustrated, a list of documents related to a particular document-matter description, “DBox Test Matter#2” is displayed to a user. A user then executes a search by activating the “search” tab 194 in the screen display.

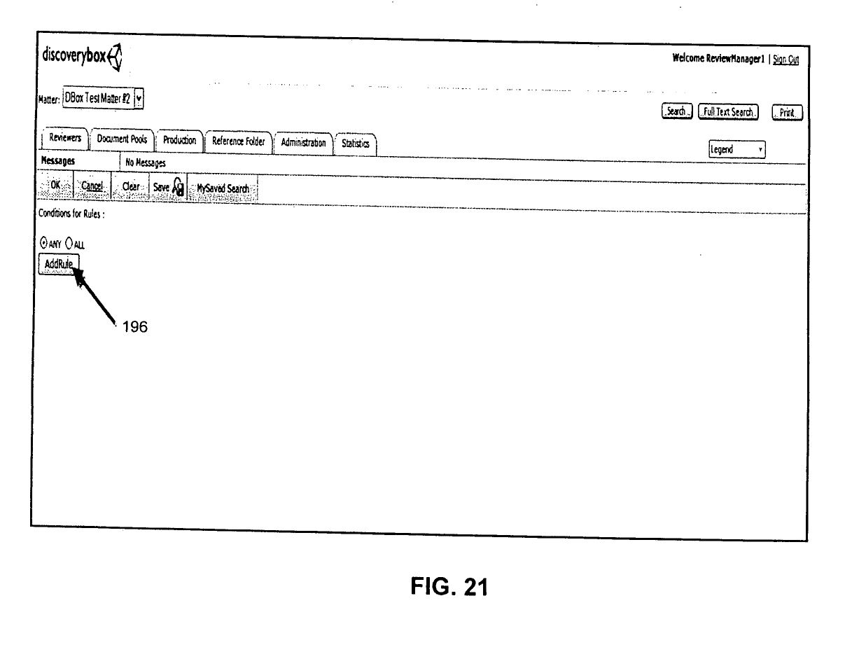

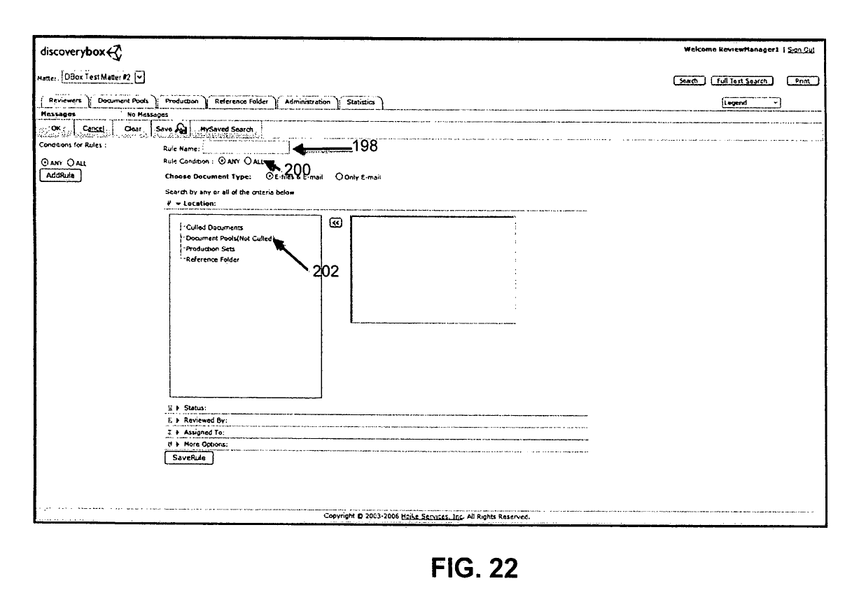

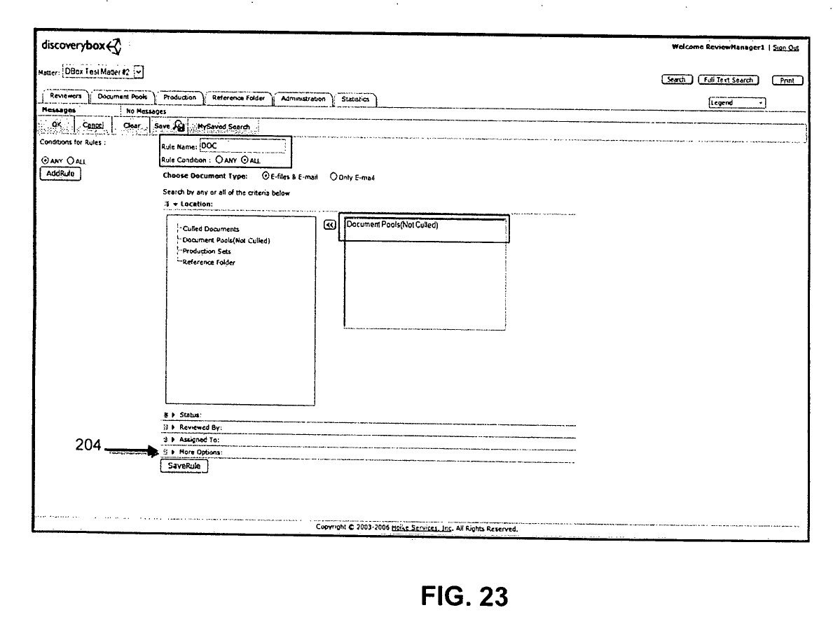

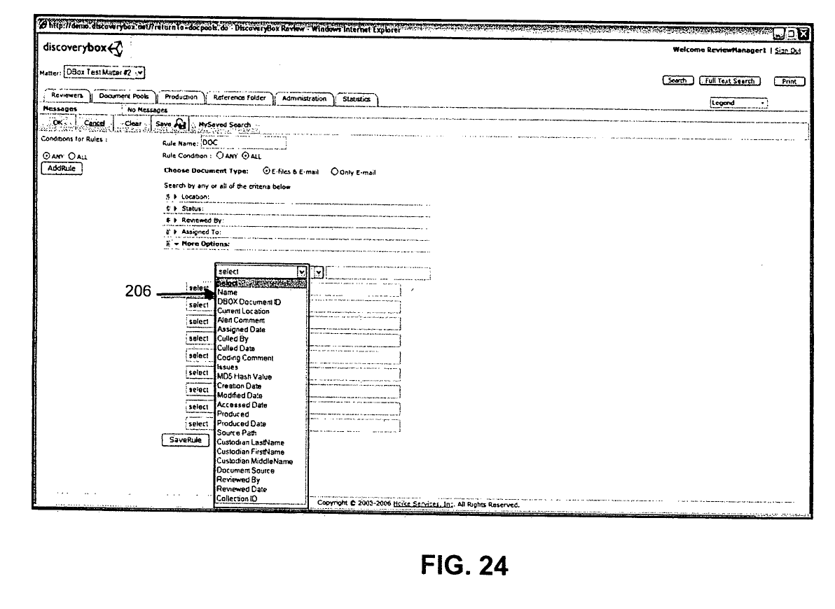

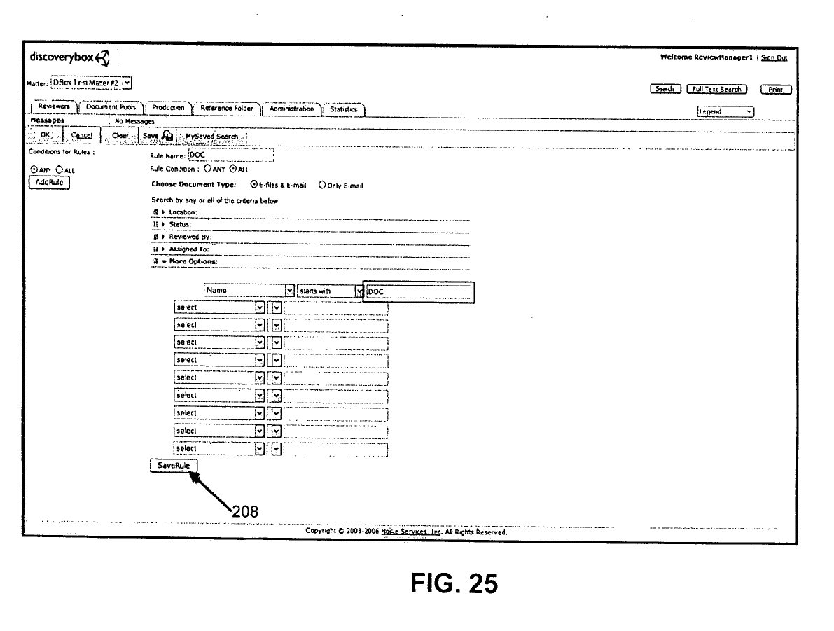

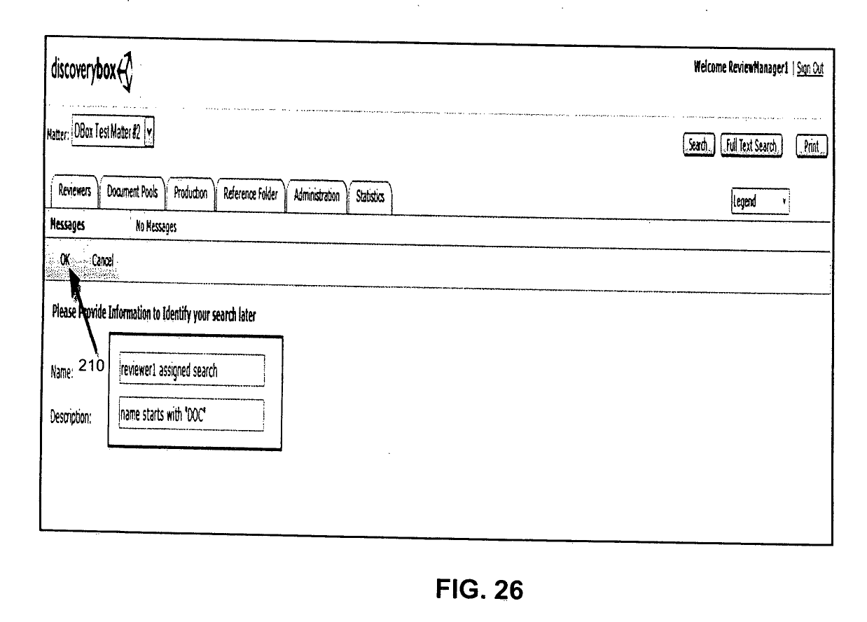

FIGS. 21-26 are exemplary screen displays presented to a user to generate a search string based on search criteria. A user first activates an “AddRule” button 196 as illustrated in the screen display shown in FIG. 21. A user is then presented with a screen display as illustrated in FIG. 22, with options to define a search rule. As illustrated, the search rule includes a rule name 198, a rule condition 200 and a rule location 202. In one example, a user sets the rule name to “DOC”, the rule condition to “ALL” and the location to “Document Pools” as illustrated in the screen display shown in FIG. 23. The user then activates a “More Options” tab 204 to add more definitions to the search rule. The “More Options” tab 204 presents the user with a screen display as illustrated in FIG. 24. In one example, the user chooses a data field, “name” 206, to search by the document's name. The user then chooses specific criteria to generate a search string that searches for documents that start with DOC in their file name as illustrated in the screen display shown in FIG. 25. The user saves the generated search string by activating a “SaveRule” button 208. Upon activating the “SaveRule” button 208, the user is presented with a screen display as shown in FIG. 26. The user specifies a name for the saved search string as “reviewer1 assigned search” and saves the search string with this name by activating an “OK” button 210.

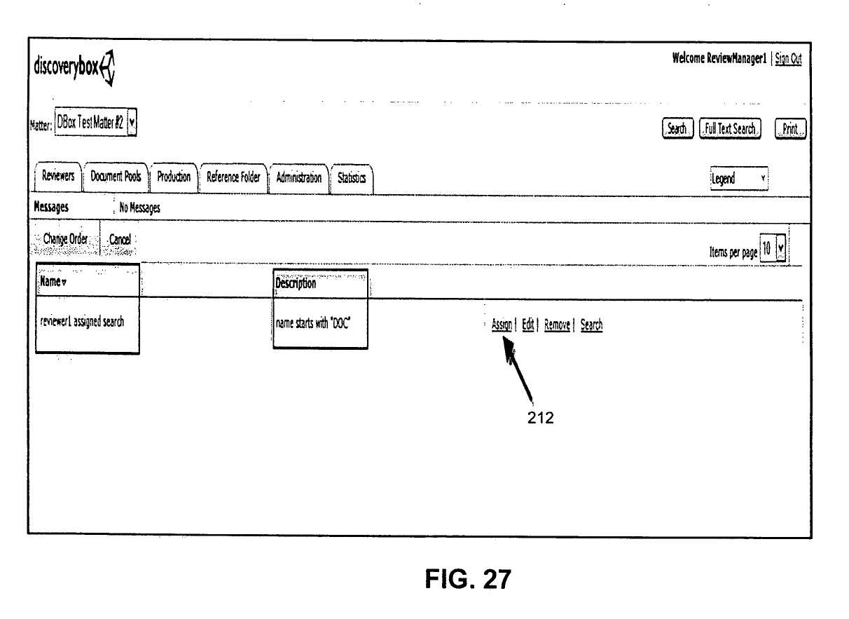

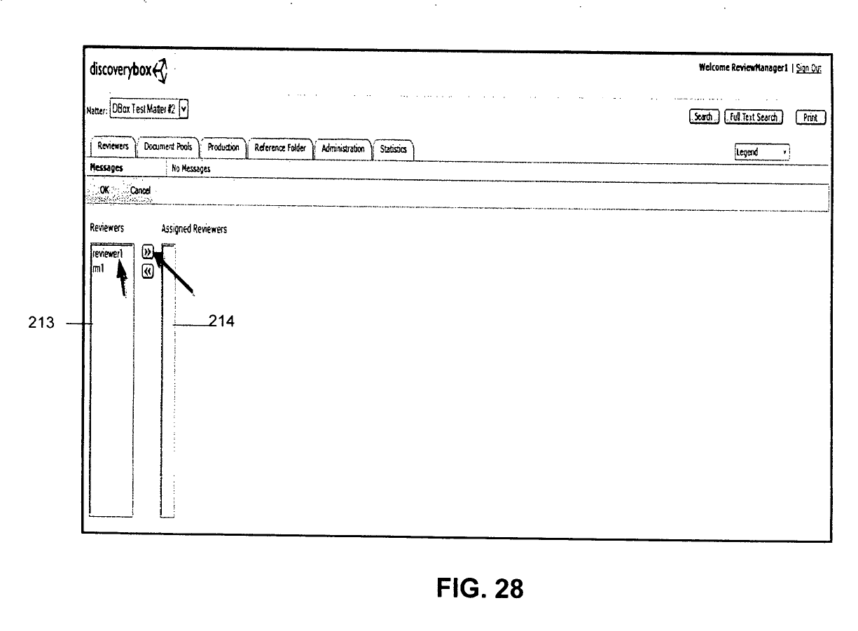

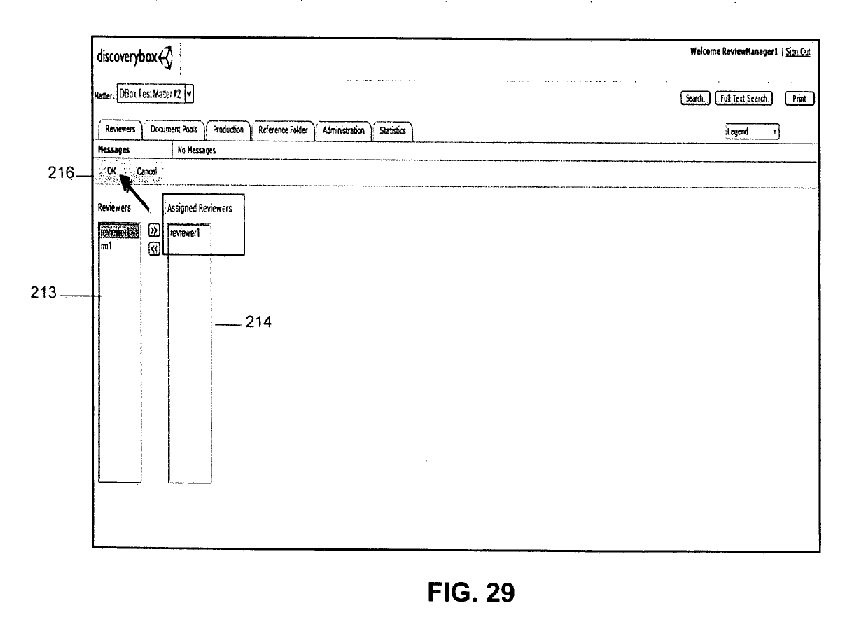

FIGS. 27-29 are exemplary screen displays presented to a user to assign the generated search string to a specific reviewer. The user activates an “Assign” button 212 to assign the generated search string to the specific reviewer, in this case “reviewer1” as illustrated in the screen display shown in FIG. 27. An assigned search screen is displayed to the user, as illustrated in FIG. 28. The assigned search screen displays a “reviewer box” 213 and an “assigned reviewers” box 214. To assign the search, the user selects “reviewer1” and moves it to the “assigned reviewers” box 214, as shown in the screen display illustrated in FIG. 29. The user then selects an “OK” button 216 to assign the reviewer to the generated search string.

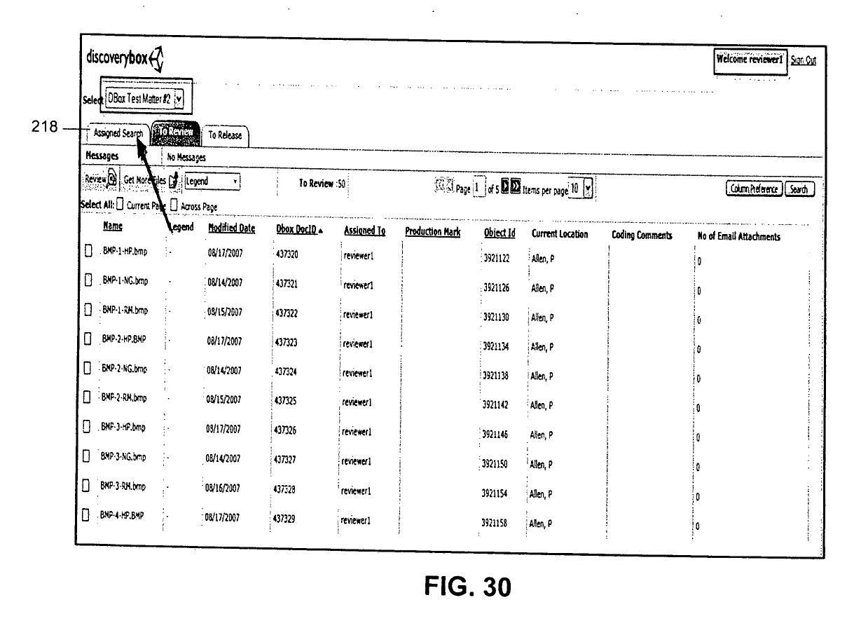

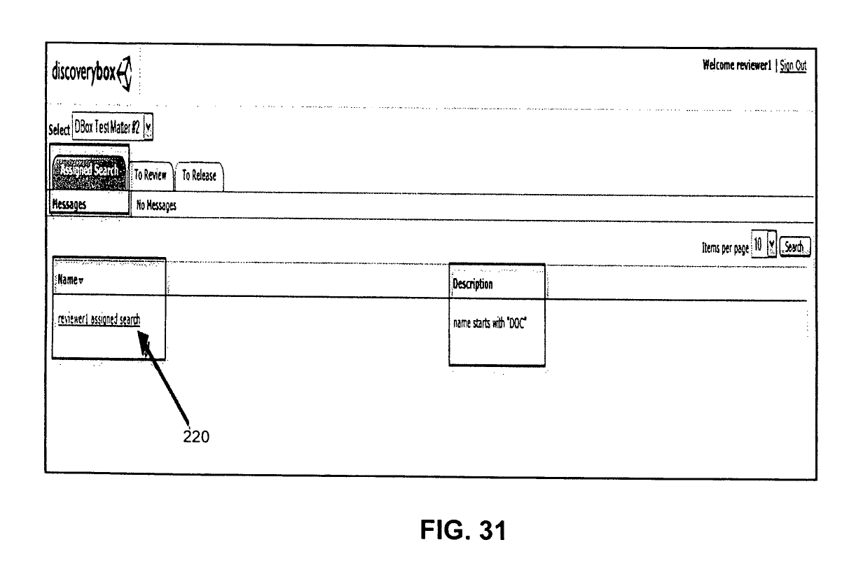

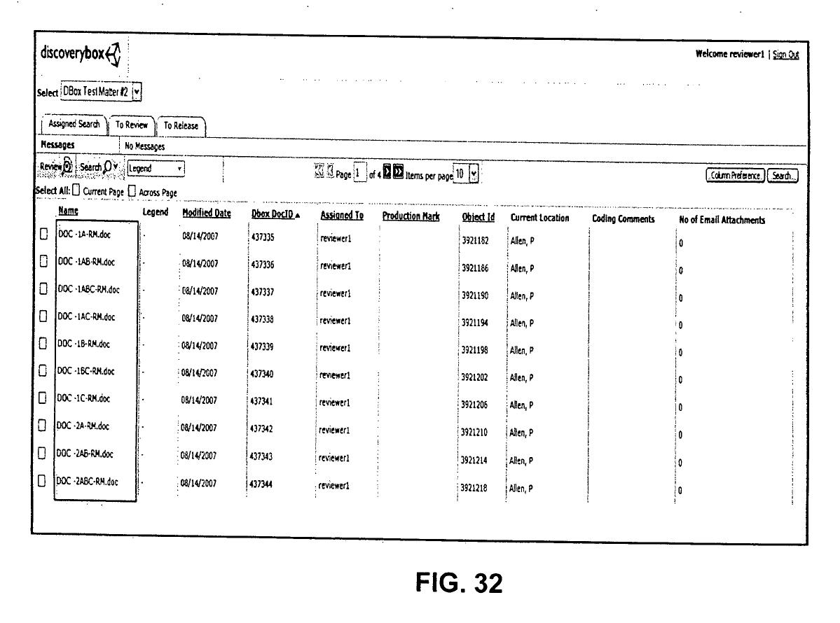

FIGS. 30-32 are exemplary screen displays presented to a user to execute and display the generated search string. A user activates an “Assigned Search” tab 218 to display all the searches assigned to a particular reviewer as illustrated in the screen display shown in FIG. 30. The “Assigned Search” tab 218 when activated displays all the searches assigned to a particular reviewer, “reviewer1”. The search is entitled “reviewer1 assigned search” 220 as illustrated in the screen display shown in FIG. 31. The user then activates the “reviewer1 assigned search” tab 220 to execute the assigned search on the documents currently assigned to reviewer1. After executing the assigned search, a resultant data set comprising one or more documents assigned to reviewer1 that match the criteria in the search string is displayed to a user, as illustrated in the screen display shown in FIG. 32.

One skilled in the art will recognize a number of advantages associated with the disclosed technique. A review manager can assign reviewers with multiple searches, such as, for example, a search that highlights certain keywords associated with potentially privileged documents and/or a search that highlights certain keywords associated with a specific case issue. Focused searches executed against documents assigned to specific reviewers increase the efficiency of the reviewer's review process. In addition, they organize the review process, generate more consistent results across the review process and enhance the speed of the review process.

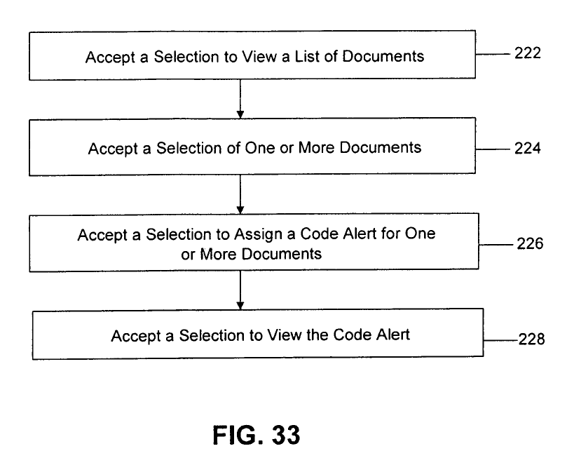

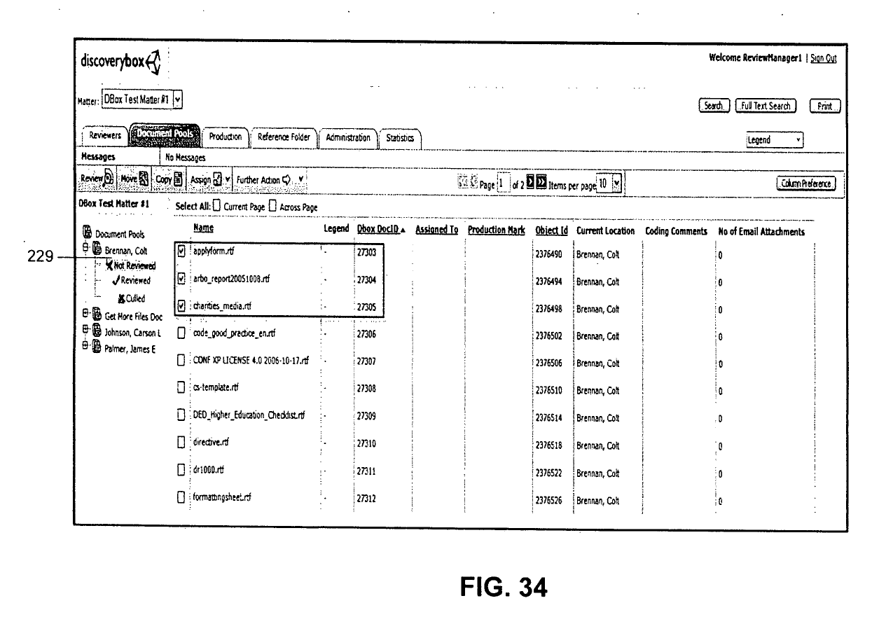

In accordance with a fourth aspect of the present invention, exemplary operations to assign a code alert are disclosed. In one embodiment, the code alert operation is performed by the Code Alert Module 118. FIG. 33 is a flowchart illustrating exemplary operations performed to assign a code alert, in accordance with one embodiment of the present invention. A selection to view a list of documents is accepted 222. A selection of a document from the list of documents is accepted 224. A selection to create a code alert for a document is accepted 226. A selection to view the code alert is accepted 228. The operations 222-228 are more clearly understood with reference to the Graphical User Interface (GUI) screen displays shown in FIGS. 34-40.

FIG. 34 is an exemplary screen display that is presented to a user to view a list of documents. The user then selects documents from the list of documents. As illustrated, the user selects three documents from the “Brennan, Colt” document pool 229.

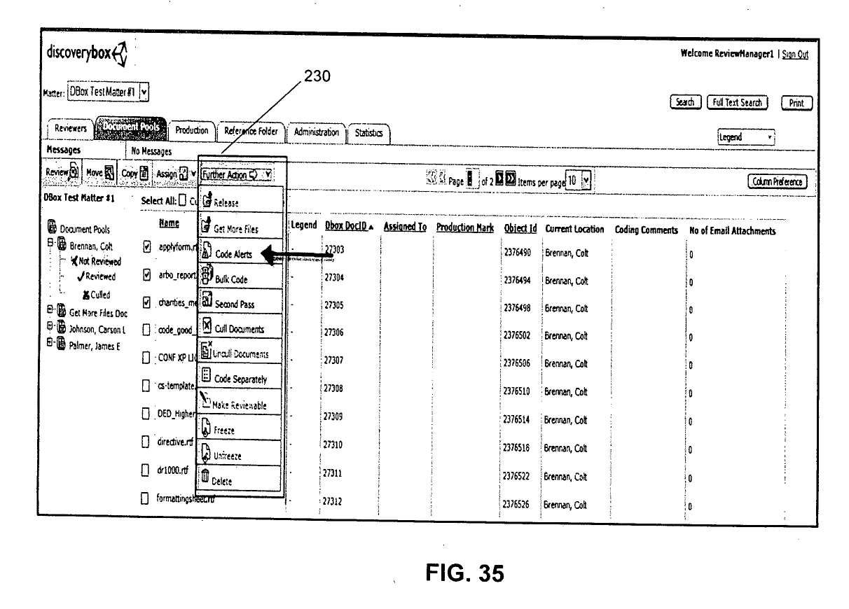

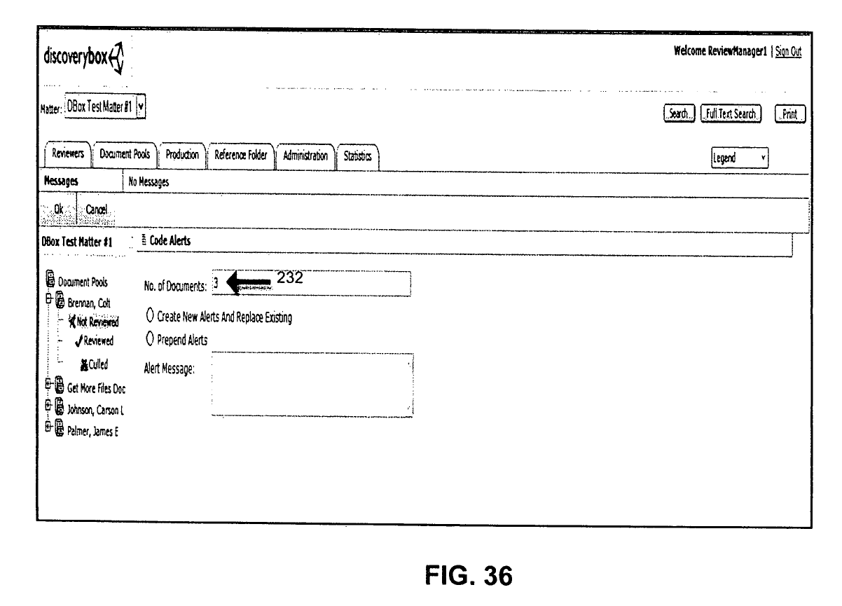

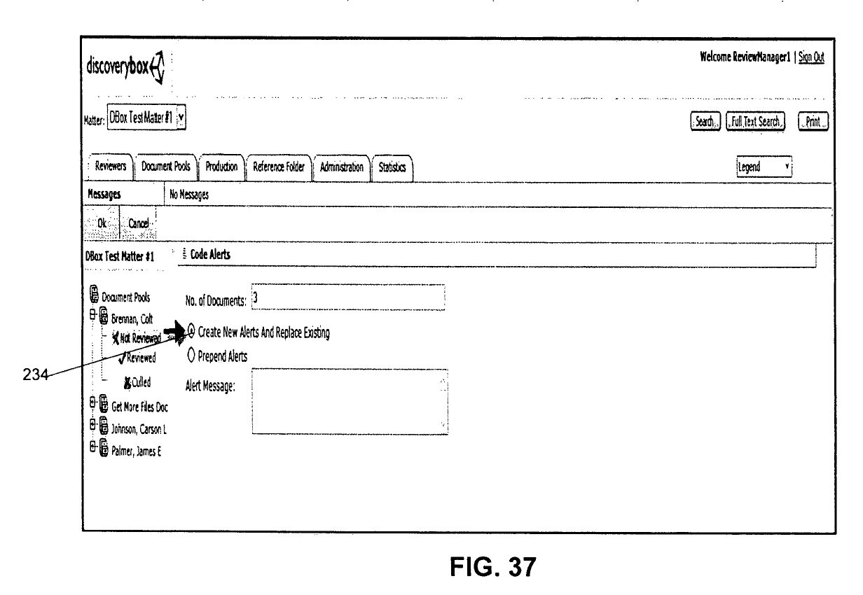

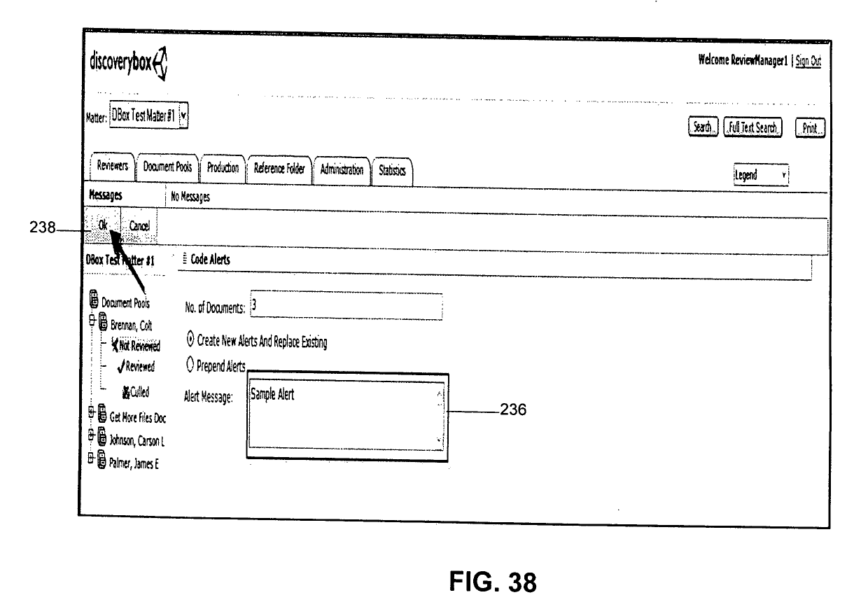

FIGS. 35-38 are exemplary screen displays presented to a user to create a code alert for the selected documents. As illustrated in the screen display of FIG. 35, the user activates a “Further Action” tab 230 to create a code alert for the selected documents. A code alert screen is displayed with the selected number of documents 232, as illustrated in FIG. 36. To create a code alert, the user then activates a radio button, “Create New Alerts and Replace Existing” 234 as illustrated in the screen display shown in FIG. 37. The user then specifies a name for the code alert as “Sample Alert” 236, as illustrated in the screen display shown in FIG. 38. A code alert is then created with the specified name, when the user activates the OK button 238 on the screen display.

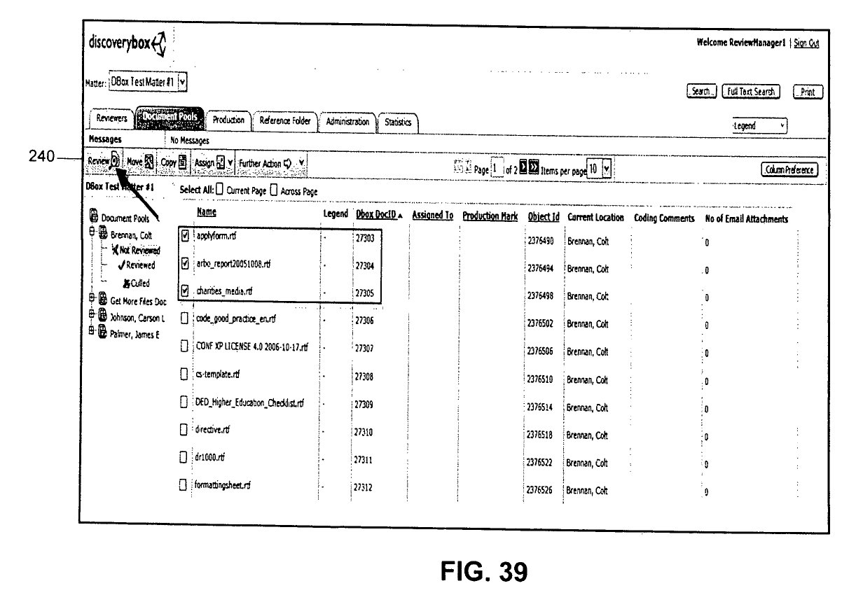

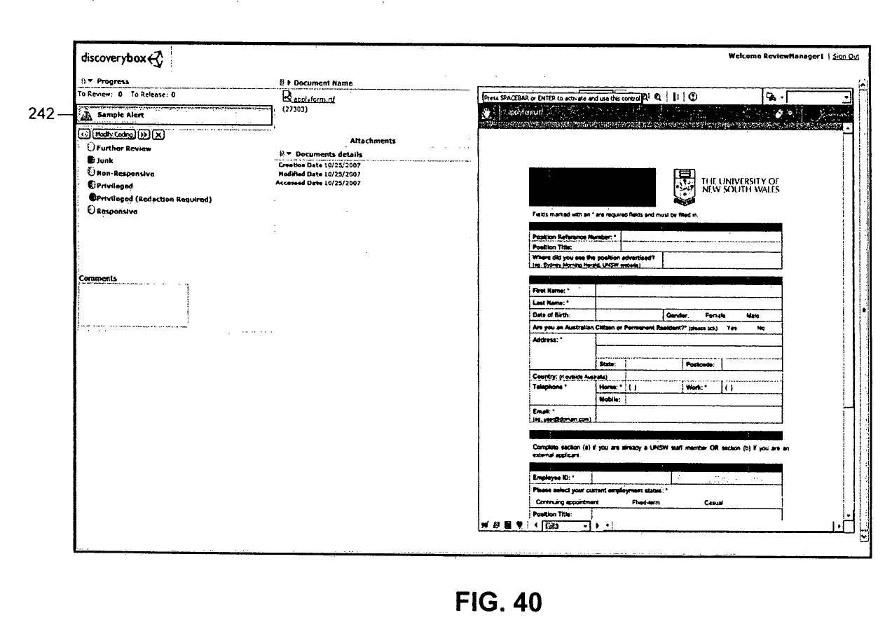

FIGS. 39-40 are exemplary screen displays presented to a user to view code alerts assigned to the selected documents. To view the newly created code alert for the selected documents, the user activates a “Review” button 240, as illustrated in the screen display shown in FIG. 39. The code alert message assigned to the selected documents is illustrated in the screen display shown in FIG. 40. The code alert message, “Sample Alert” 242 serves as a guide to individual reviewers on how to code a document being reviewed, resulting in a more consistent review process and an increase in the review speed. In one example, the user may code the document into one or more of the following categories: “Further Review”, “Junk”, “Non-responsive”, “Privileged” and “Responsive”, as illustrated.

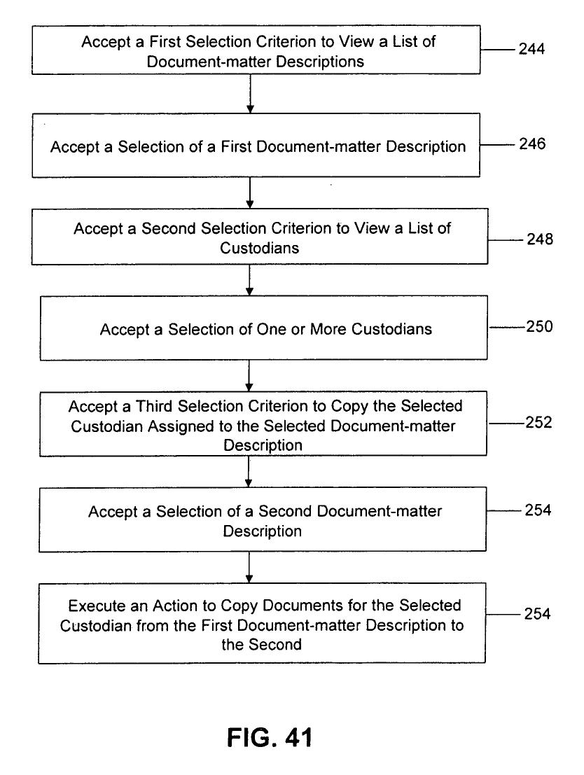

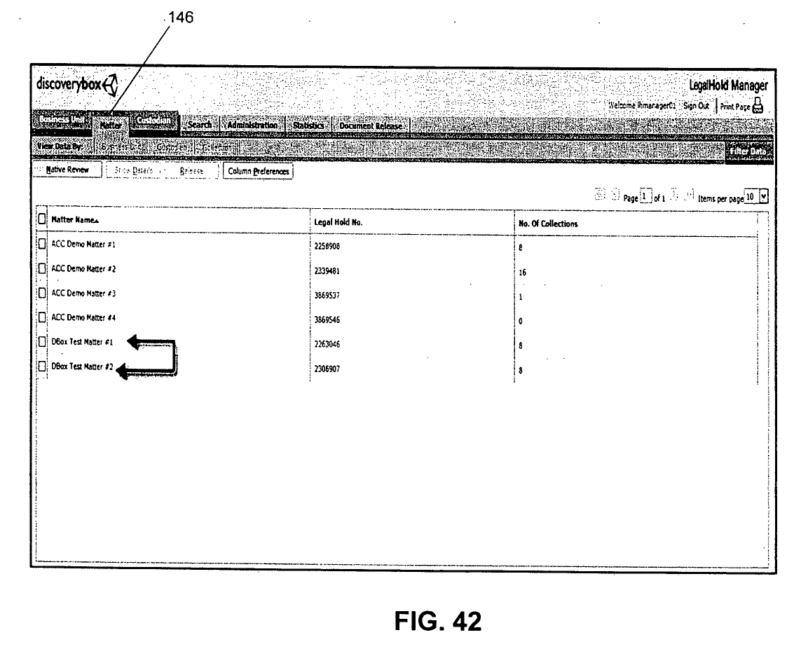

In accordance with a fifth aspect of the present invention, exemplary operations to re-use documents associated with a custodian are disclosed. In one embodiment, the re-use operation is performed by a Document Re-use Module 120. FIG. 41 is a flowchart illustrating exemplary operations performed to re-use documents, in accordance with one embodiment of the present invention. A first selection criterion to view a list of document-matter descriptions is accepted 244. A selection of a first document-matter description from the list of document-matter descriptions is accepted 246. A second selection criterion to view a list of custodians assigned to the selected document-matter description is accepted 248. A selection of one or more custodians from the list of custodians is accepted 250. A third selection criterion to copy the selected custodian assigned to the selected document-matter description is accepted 252. A selection of a second document-matter description is accepted 254. An action to copy documents associated with the selected custodian from the first document-matter description to the second document-matter description is executed 256. The operations 244-256 are more clearly understood with reference to the Graphical User Interface (GUI) screen displays shown in FIGS. 42-46.

FIG. 42 is an exemplary screen display presented to a user to view a list of document-matter descriptions. As illustrated, the user activates a “matter” tab 146 in the screen display to view a list of document-matter descriptions. Each document-matter description has an associated legal hold number indicating the presence of a legal hold on the document-matter description and a specified number of collections indicating the number of collections made against custodians assigned to a particular document-matter description. In one embodiment, a set of operations executed to copy a custodian's documents from a source location, “DBox Test Matter #1” to a destination location, “DBox Test Matter #2” is further illustrated in the screen shots shown below.

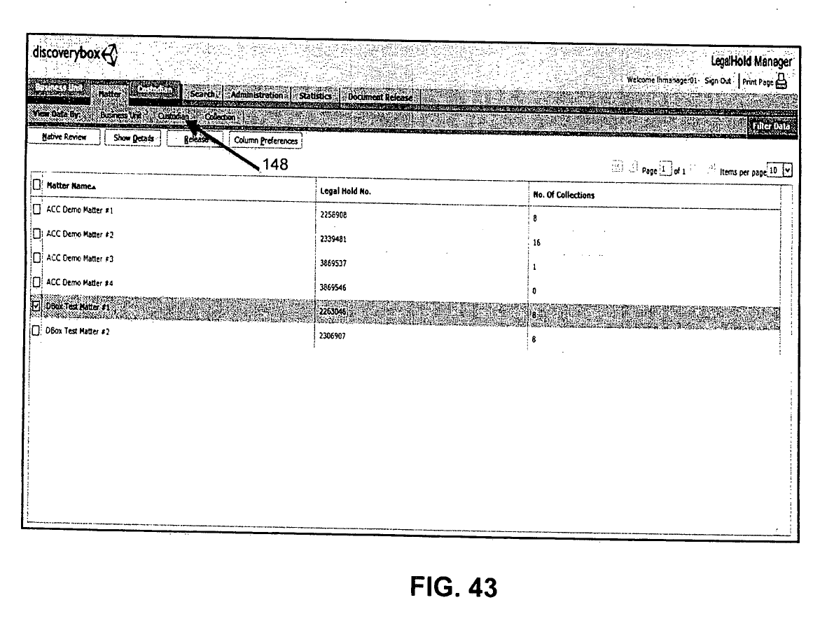

FIG. 43 is an exemplary screen display presented to a user to select a first document-matter description. In one example, the user selects the document-matter description entitled, “DBox Test Matter#1” from the list of document-matter descriptions. The user then activates the “custodian” tab 148 in the screen display to view a list of custodians assigned to the document-matter description, “DBox Test Matter#1”.

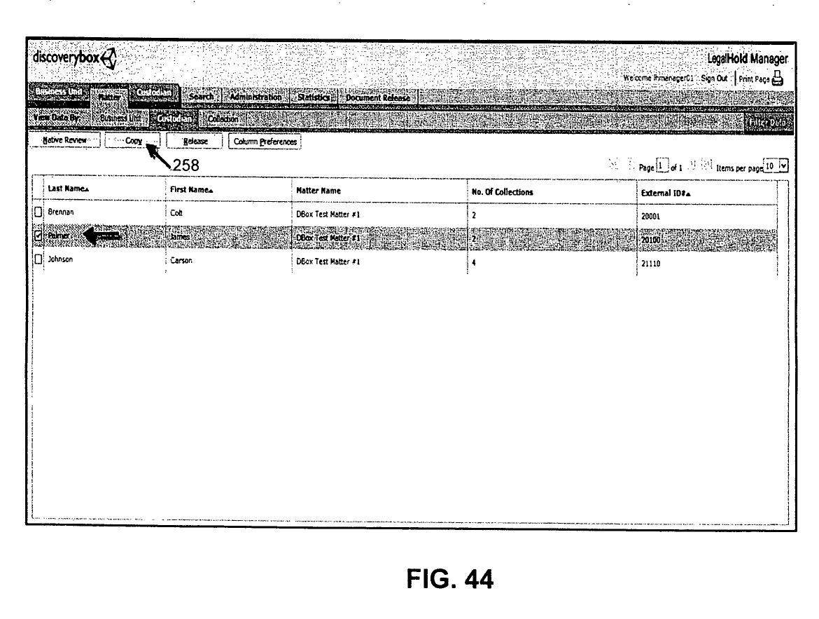

FIG. 44 is an exemplary screen display that displays a list of custodians assigned to a document-matter description. In the illustrated example, a list of custodians assigned to the document-matter description, “DBox Test Matter #1” is displayed. The user then selects a particular custodian from the list of custodians. In the illustrated example, the user selects the custodian, “Palmer, James”. The user then executes an operation to copy the selected custodian's documents from the specified source location, in this case, “DBox Test Matter#1” by activating the “copy” tab 258 in the screen display.

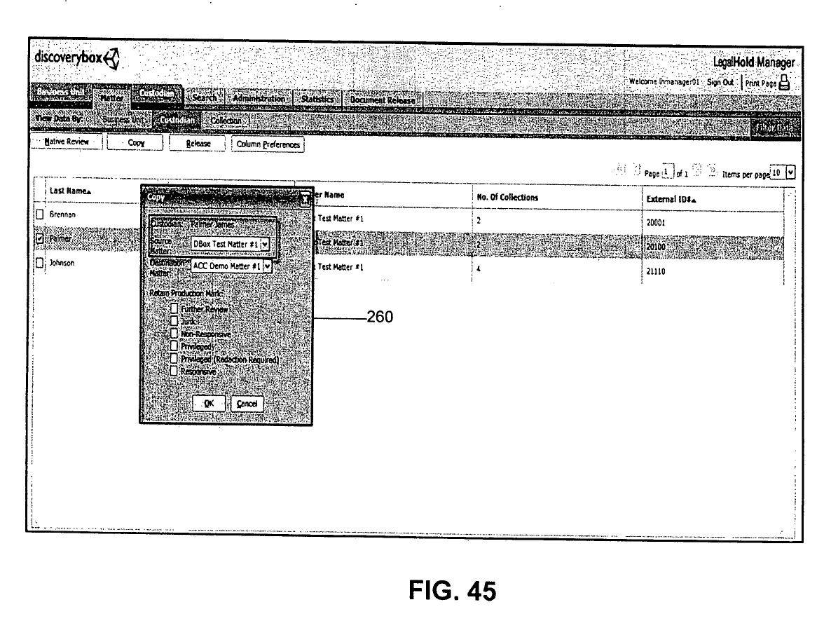

FIG. 45 is an exemplary screen display presented to a user to copy a selected custodian assigned to a selected document-matter description. Upon activation of the copy tab 258, a copy window 260 with the selected custodian, “Palmer, James” and the selected document-matter description, “DBox Test Matter#1” are displayed to the user. This indicates to the user that a copy operation will be performed on the selected custodian's documents in the selected source document-matter description.

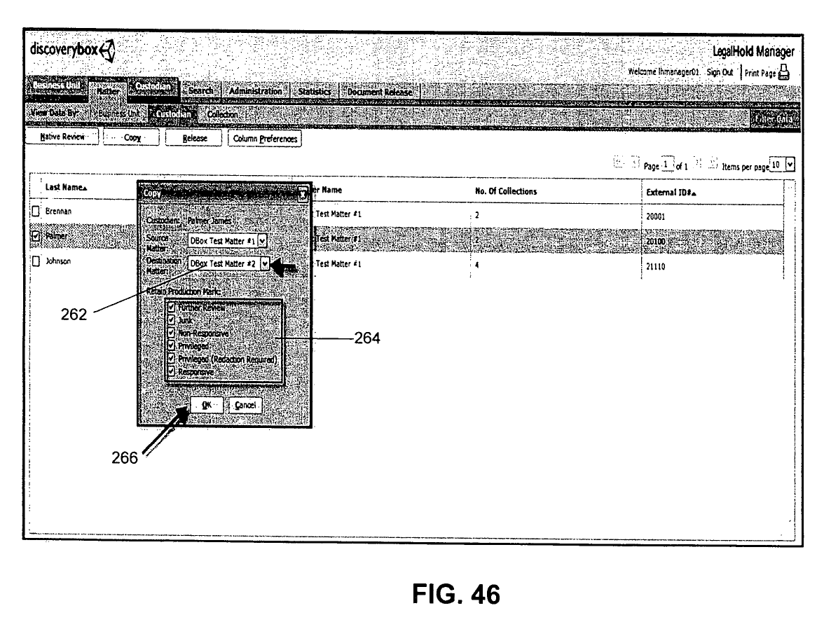

FIG. 46 is an exemplary screen display presented to a user to select a second document-matter description and execute an action to copy documents. In one example, the user selects “DBox Matter#2” as the destination location 262 to copy the documents associated with selected custodian, “Palmer James” from the specified source location, “DBox Matter#1”. The illustrated screen display also indicates that the user chooses to preserve all the review call categories 264, “Further Review”, “Junk”, “Non-Responsive”, “Privileged”, “Privileged” (Reaction required) and “Responsive” in the documents that are copied to “DBox Test Matter#2”. The user then executes an action to copy the documents associated with the selected custodian from the first document-matter description to the second document-matter description by activating the “OK” button 266 in the screen display.

One skilled in the art will recognize that the disclosed technology of leveraging and re-using a custodian's document collections saves document review time and costs that would otherwise be spent on re-reviewing documents and also minimizes business disruption and costs associated with re-collecting the same documents repeatedly from the same custodians.

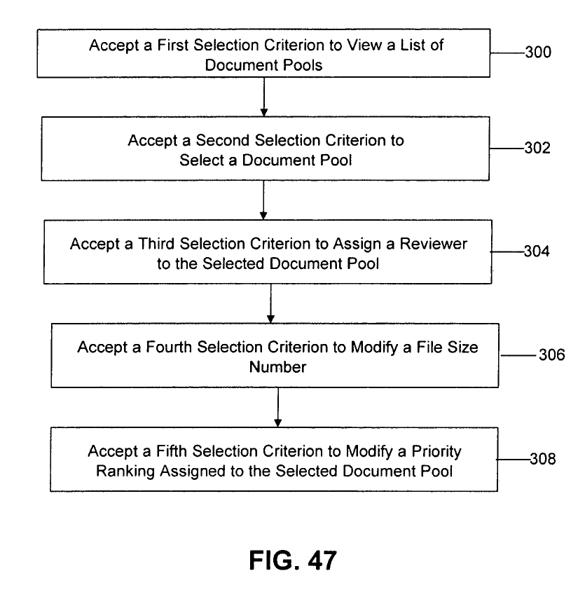

According to a sixth aspect of the present invention, exemplary operations to manage a document assignment and review process are disclosed. In one embodiment, this operation is performed by the Document Assignment and Review Management Module 122. In a particular embodiment, the Document Assignment and Review Management Module 122 includes executable instructions to assign one or more reviewers to a document pool and assign a file size number to each reviewer requesting documents from the document pool. FIG. 47 is a flowchart illustrating exemplary operations performed for managing a document assignment and review process. A first selection criterion to view a list of document pools is accepted 300. Each document pool includes a set of documents. A second selection criterion to select a document pool from the list of document pools is accepted 302. A third selection criterion to assign one or more reviewers to the selected document pool is accepted 304. A fourth selection criterion to modify a file size number assigned to one or more of the reviewers requesting one or more documents from the selected document pool is accepted 306. A fifth selection criterion to modify a priority ranking assigned to the selected document pool is accepted 308.

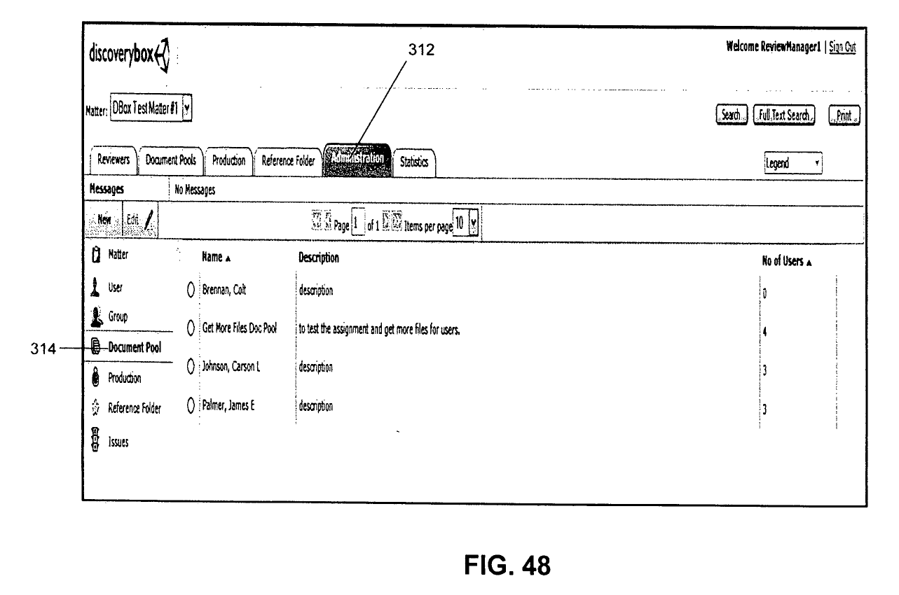

FIG. 48 is an exemplary screen display presented to a user to view a list of document pools. As illustrated, the user activates the “Document Pool” screen 314 within an “administration” tab 312 in the screen display to view a list of document pools. Each document pool is identified by an associated description and a specified number of assigned users. For example, in the illustrated example, the document pool “Johnson, Carson L” has three users assigned to it and the document pool, “Brennan, Colt” has no users assigned to it.

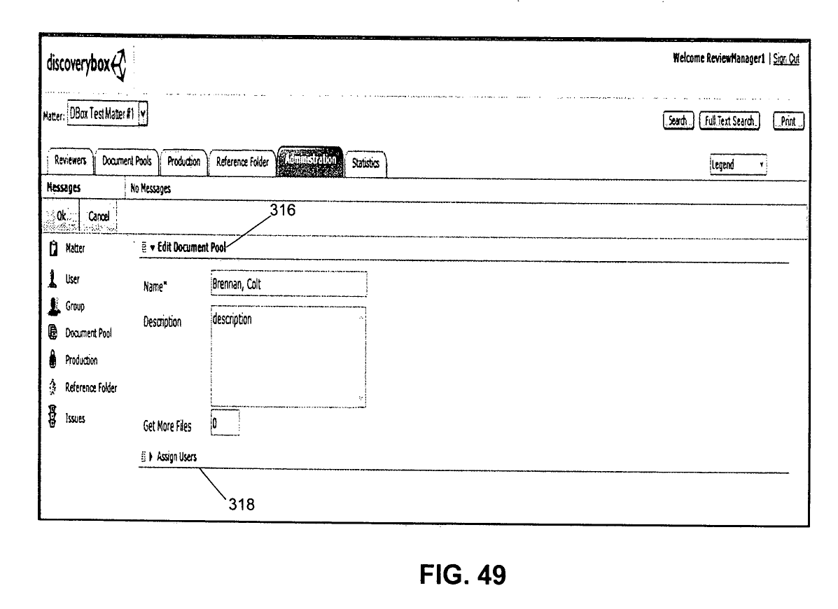

FIG. 49 is an exemplary screen display presented to a user to edit a document pool selected from a list of document pools. As illustrated, the user activates an “Edit Document Pool” Screen 316 to edit a document pool. In the illustrated example, the user selects the “Brennan, Colt” document pool to edit. The user then edits the “Brennan, Colt” document pool, by activating an “Assign Users” tab 318 to assign reviewers to the document pool.

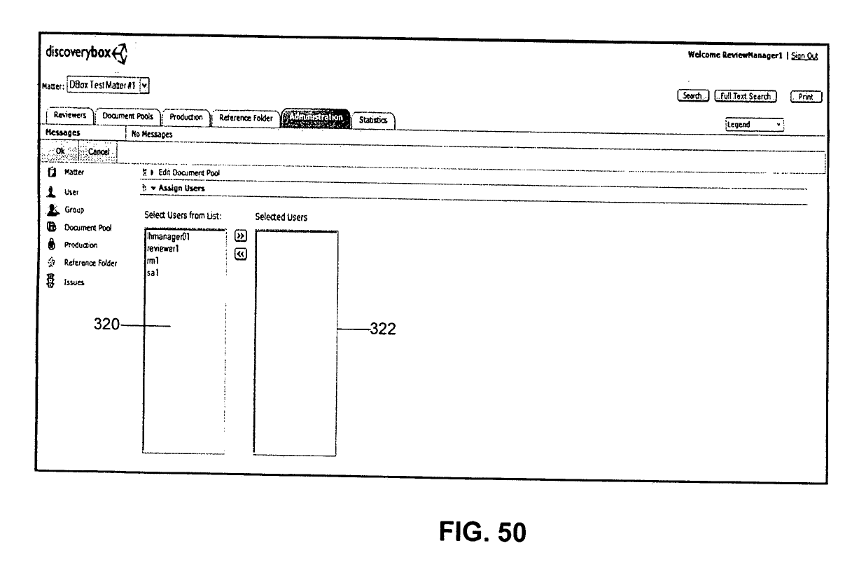

FIG. 50 is an exemplary screen display presented to a user to assign reviewers to a selected document pool. Upon activation of the “Assign Users” tab 318, the user is presented with the screen display shown in FIG. 50. To assign reviewers to a particular document pool, a user selects one or more users from the “Selected Users from List” box 320 and moves them to the “Selected Users” box 322.

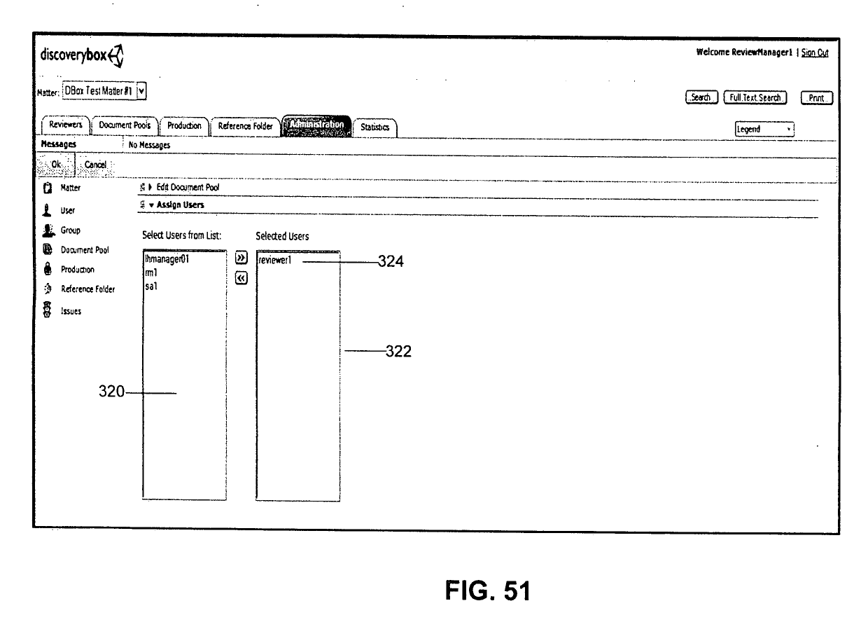

FIG. 51 is an exemplary screen display of a reviewer assigned to a selected document pool. In the illustrated example, “reviewer 1” 324 is selected from the “Selected Users from List” box 320 and is assigned to the “Brennan, Colt” document pool.

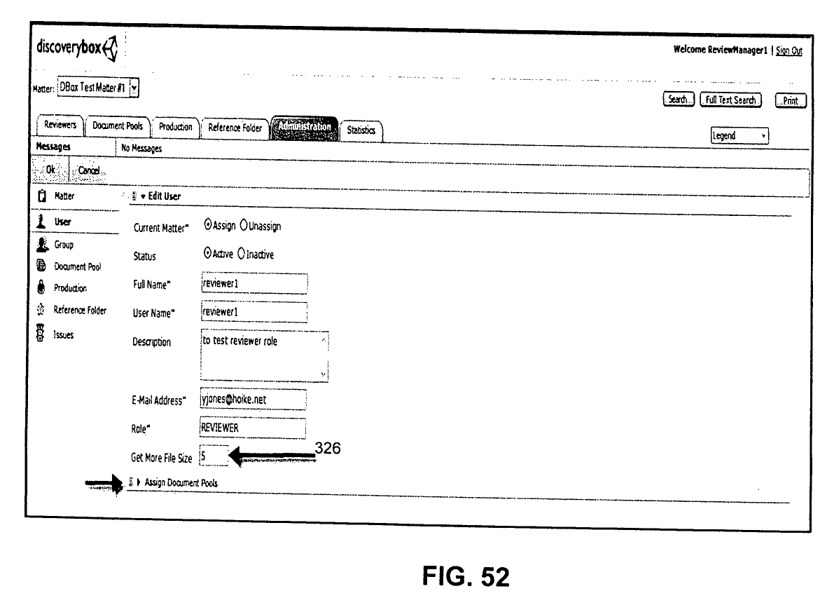

FIG. 52 is an exemplary screen display presented to a user to modify a file size number assigned to a reviewer requesting documents from a document pool. As used herein, a file size number defines the number of documents that a reviewer automatically receives when requesting more files to review. As illustrated, a “Get More File Size” box 326 is used to set the file size number for each reviewer.

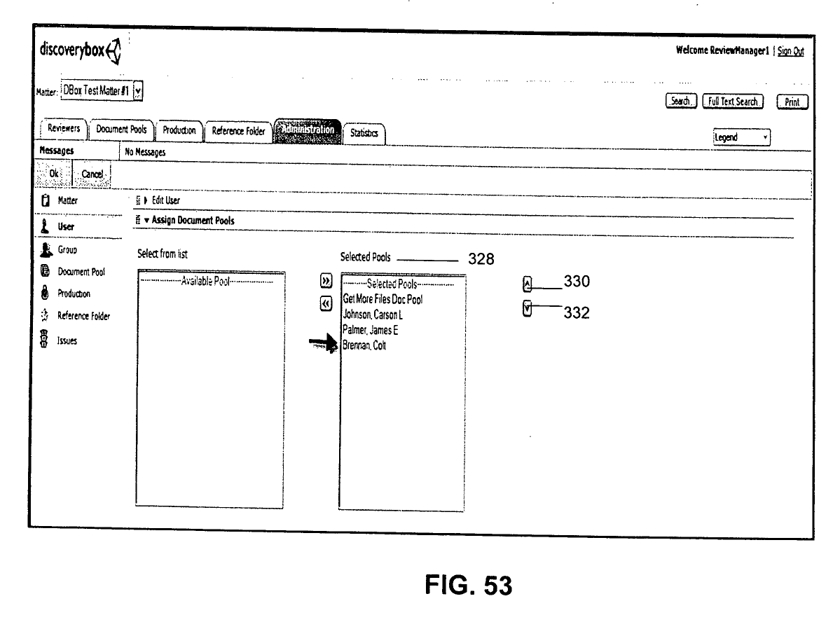

FIG. 53 is an exemplary screen display presented to a user to modify a priority ranking assigned to a document pool. As illustrated, a user can order document pools in a desired priority by moving the document pools in the “Selected Pools” list 328 using the “up” and “down” arrows, 330 and 332 respectively. A reviewer requesting more files to review will automatically be assigned documents in order from the highest priority document pool to the lowest priority document pool, until all the documents are exhausted. In the illustrated example, the selected document pool, “Brennan, Colt” will be moved to the top of the list in the “Selected Pools” list 328 and will be given the highest priority, indicating that documents will be retrieved from this pool first.

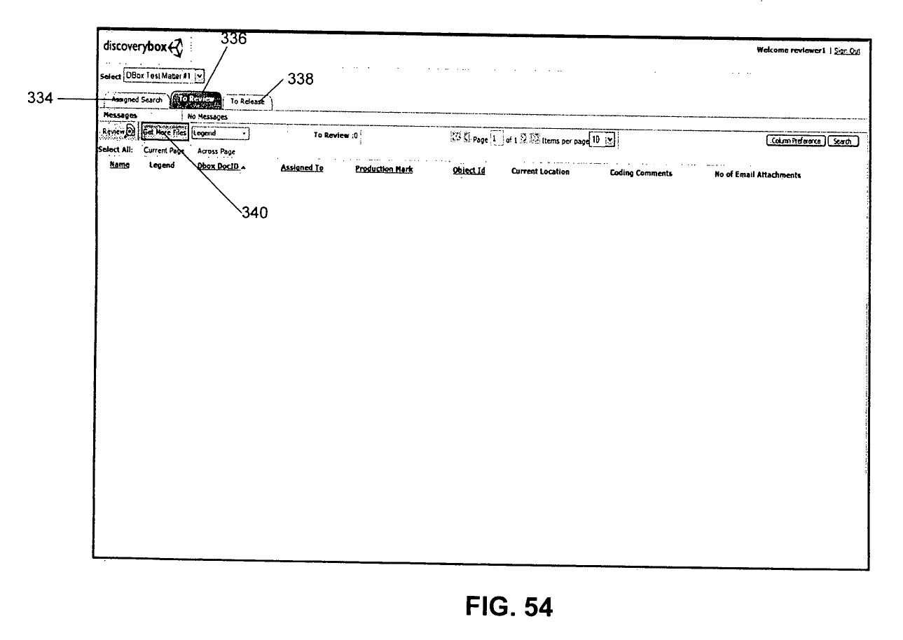

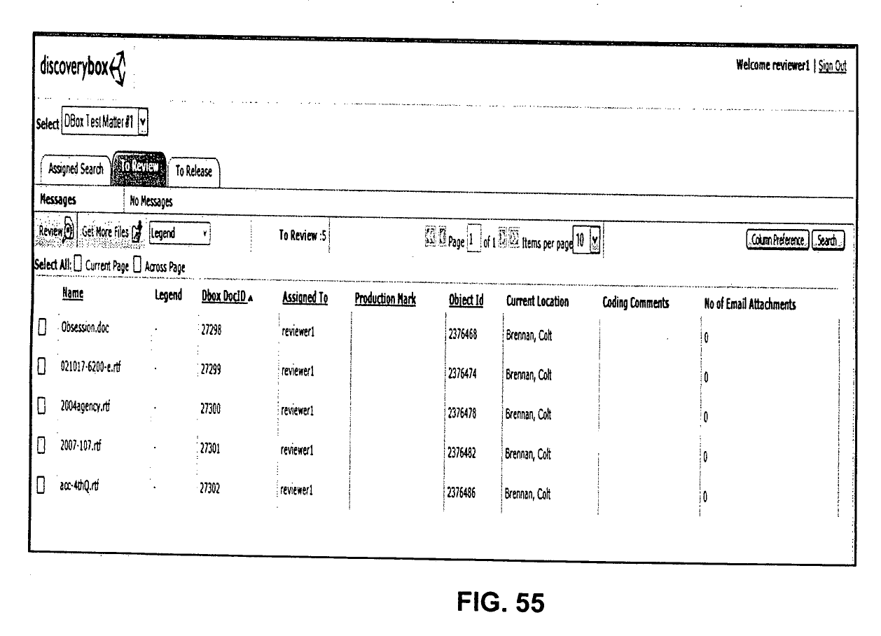

FIG. 54 is an exemplary review screen presented to a reviewer to manage the document assignment and review process. As illustrated, the review screen displays an “Assigned Search” tab 334, a “To Review” tab 336, a “To Release” tab 338 and a “Get More Files” tab 340. If the “To Review” tab 336 and the “To Release” tab 338 do not display any documents to review, the reviewer selects the “Get More Files” tab 340 to automatically retrieve documents for review from the assigned document pool. The “Get More Files” tab 340 automatically assigns a number of documents equal to the number of documents set for the reviewer in the “Get More File Size” box 326 illustrated in FIG. 52. The user is then presented with the screen display illustrated in FIG. 55. The illustrated screen display displays the files assigned to a reviewer. In the illustrated example, “reviewer 1” is automatically presented with five files from the Brennan, Colt document pool for review.

The disclosed technology enables the automatic assignment and review of documents for a reviewer. Reviewers can extract documents directly from a document pool as opposed to waiting for a Review Manager to manually assign documents to them. Each reviewer simply performs a “Get More Files” operation to request additional documents to review. In addition, reviewers can be assigned multiple document pools which can then be prioritized. Therefore, a reviewer can control the review process by selecting documents in document pools in accordance with their assigned priority. Furthermore, since multiple reviewers can be assigned to a single document pool, the Review Manager has the flexibility to create specialized document pools and assign a team of reviewers with specialized skills to a single pool for review.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer readable storage medium comprising executable instructions to:
manage documents subject to legal holds by performing two or more of the following operations:
manage a document release;
execute a drill down analysis;
execute an assigned search;
assign a code alert;
re-use documents associated with a custodian; and
manage a document assignment and review process.

2. The computer readable storage medium of claim 1, wherein the executable instructions to manage a document release comprise executable instructions to manage a release of a legal hold of one or more custodians assigned to one or more document-matter descriptions.

3. The computer readable storage medium of claim 2, wherein the executable instructions to manage a document release further comprise executable instructions to:
accept a first selection criterion to view a list of document-matter descriptions related to the documents;
accept a selection of one or more document-matter descriptions from the list of document-matter descriptions;
accept a second selection criterion to view a list of custodians assigned to one or more of the selected document-matter descriptions;
accept a selection of one or more custodians from the list of custodians; and
execute an action to release each of the selected custodians assigned to each of the selected document-matter descriptions.

4. The computer readable storage medium of claim 3, further comprising executable instructions to enter a password to confirm the release of each selected custodian.

5. The computer readable storage medium of claim 3, further comprising executable instructions to release a plurality of documents associated with the selected custodian assigned to the selected document-matter description.

6. The computer readable storage medium of claim 1, wherein the executable instructions to execute a drill down analysis comprise executable instructions to perform a drill down analysis of relationships between at least one of one or more business units, one or more custodians, one or more collections, and one or more document-matter descriptions related to the documents.

7. The computer readable storage medium of claim 6, wherein the executable instructions to perform a drill down analysis further comprise executable instructions to perform a first-level drill down analysis of one or more business units associated with one or more document-matter descriptions.

8. The computer readable storage medium of claim 7, wherein the executable instructions to perform a first-level drill down analysis further comprise executable instructions to:
accept a first selection criterion to view a list of document-matter descriptions related to the documents;
accept a selection of one or more document-matter descriptions from the list of document-matter descriptions;
accept a second selection criterion to view a list of business units associated with one or more of the selected document-matter descriptions; and
obtain a first-level drill down resultant list that displays the business units associated with one or more of the selected document-matter descriptions.

9. The computer readable storage medium of claim 8, further comprising executable instructions to perform a second-level drill down analysis of one or more custodians associated with one or more business units and one or more document-matter descriptions based on the first-level drill down resultant list.

10. The computer readable storage medium of claim 9, wherein the executable instructions to perform a second-level drill down analysis further comprise executable instructions to obtain a second-level drill down resultant list that displays one or more custodians associated with each of the selected business units for each of the selected document-matter descriptions.

11. The computer readable storage medium of claim 10, further comprising executable instructions to perform a third-level drill down analysis of one or more collections associated with one or more custodians, one or more business units and one or more document-matter descriptions based on the second-level drill down resultant list.

12. The computer readable storage medium of claim 11, wherein the executable instructions to perform a third-level drill down analysis further comprise executable instructions to obtain a third-level drill down resultant list that displays one or more collections associated with one or more custodians for each of the selected business units and each of the selected document-matter descriptions.

13. The computer readable storage medium of claim 1, wherein the executable instructions to execute an assigned search comprise executable instructions to generate one or more reviewer-specific search strings.

14. The computer readable storage medium of claim 13, wherein the executable instructions to generate reviewer-specific search strings further comprise executable instructions to:
accept a selection to execute a search related to a document-matter description comprising documents assigned to a specific reviewer;
accept a selection to generate a search string to be executed on the documents based on a plurality of search criteria;
accept a selection to assign the generated search string to the specific reviewer; and
accept a selection to execute the generated search string to display a resultant data set comprising one or more documents assigned to the reviewer that match the search criteria in the generated search string.

15. The computer readable storage medium of claim 1, wherein the executable instructions to assign a code alert comprise executable instructions to:
accept a selection of one or more documents from a list of documents;
accept a selection to create a code alert for the one or more documents; and
accept a selection to view the code alert.

16. The computer readable storage medium of claim 1, wherein the executable instructions to re-use documents associated with a custodian comprise executable instructions to re-use documents associated with a custodian between one or more document-matter descriptions.

17. The computer readable storage medium of claim 16, wherein the executable instructions to re-use documents associated with a custodian further comprise executable instructions to:
accept a first selection criterion to view a list of document-matter descriptions;
accept a selection of a first document-matter description from the list of document-matter descriptions;
accept a second selection criterion to view a list of custodians assigned to the selected document-matter description;
accept a selection of one or more custodians from the list of custodians;
accept a third selection criterion to copy the selected custodian assigned to the selected document-matter description;
accept a selection of a second document-matter description; and
execute an action to copy a plurality of documents associated with the selected custodian from the first document-matter description to the second document-matter description.

18. The computer readable storage medium of claim 1, wherein the executable instructions to manage a document assignment and review process comprise executable instructions to:
assign one or more reviewers to a document pool; and
assign a file size number to each reviewer requesting one or more documents from the document pool.

19. The computer readable storage medium of claim 18, further comprising executable instructions to:
accept a first selection criterion to view a list of document pools;
accept a second selection criterion to select a document pool from the list of document pools;
accept a third selection criterion to assign one or more reviewers to the selected document pool;
accept a fourth selection criterion to modify a file size number assigned to one or more of the reviewers requesting one or more documents from the selected document pool; and
accept a fifth selection criterion to modify a priority ranking assigned to the selected document pool.
